(19) United States
(12) Patent Application Publication
(10) Pub. No.: US 2013/0260681 A1
(43) Pub. Date: Oct. 3, 2013

(54) Amulet - An Intelligent Fashion Piece

(71) Applicant: AMULET, INC., Albuquerque, NM (US)

(72) Inventors: Anders Frederick David Hsi, Albuquerque, NM (US); Chia C. Yu, Henderson, NV (US)

(73) Assignee: AMULET, INC., Albuquerque, NM (US)

(21) Appl. No.: 13/804,569

(22) Filed: Mar. 14, 2013

Related U.S. Application Data
(60) Provisional application No. 61/618,912, filed on Apr. 2, 2012.

(51) Int. Cl. H04W 4/00

(52) U.S. Cl. CPC H04W 4/008
USPC 455/41.1

(57) ABSTRACT

A device worn or carried by a user includes a subsystem including a processor, memory, wireless communication interface configured for communication over a maximum range between 1 and 10 meters, indicator(s), and electrical power source. The memory stores first profile data characterizing trait(s) of the user and second profile data characterizing interest(s) of the user. The first profile data is communicated by the wireless communication interface to at least one other device located within its maximum range. The processor receives and processes profile data wirelessly communicated from one other device located within the limited range of the wireless interface. The received profile data characterizes a person or group or entity or product or service associated with the other device. The processor processes the received profile data by matching the received profile data and the locally stored second profile data, and controls the at least one indicator based upon such processing.

### CROSS-REFERENCE TO RELATED APPLICATIONS

The present application claims priority from U.S. Prov. Patent Application No. 61/618,912, filed on Apr. 2, 2013, herein incorporated by reference in its entirety.

### BACKGROUND

1. Field

The present application relates to wireless communication devices, especially but not only suited to applications in the field of social networking

2. Related Art

Small form factor wireless communication devices have been developed that store user profile information and exchange the user profile information by near field communication. Near field communication requires the communication devices touch each other (or be brought into close proximity to one another, usually no more than a few centimeters) while being suitably aligned to one another. An example of such a device is described in US Patent Publ. No. 2010/0167649. The close proximity and alignment of devices required for NFC communication requires that the users of the communication devices that are exchanging information interact in a face-to-face manner in carrying out the exchange. The initial face-to-face interaction prior to the exchange can be difficult (for example in crowded or loud public places) and inefficient as either one of the two people may decide that they are not interested in exchanging profile information with the other user.

### SUMMARY

In one aspect of the present application, an intelligent fashion piece referred to as an “Amulet fashion piece” is provided that is worn by a user. The Amulet fashion piece employs an electronic subsystem that stores profile information for the user in electronic form. The electronic subsystem is also configured to perform a variety of tasks including: i) wirelessly broadcasting the stored profile information over a limited range for wireless communication to other Amulet fashion pieces located within such limited range, ii) carrying out a profile matching process for the profile information that it receives via wireless communication from a respective other Amulet fashion piece located within such limited range, and iii) controlling one or more indicators (such as by activating one or more LED lights and/or mechanical vibrator) in accordance with the results of the profile matching process in order to report such results to the user. The profile matching process is configured to automatically determine if the user of the Amulet fashion piece is likely to be interested in the user of the other Amulet fashion piece. The limited broadcast range of wireless communication of the electronic subsystem of the Amulet fashion pieces dictates the maximum distance between the Amulet fashion pieces for the wireless broadcast of the profile information therebetween and thus limits the profile matching process that relies on the receipt of such profile information. These operations can be repeated for profile matching the user of the Amulet fashion piece to additional Amulet fashion piece users.

In one embodiment, the maximum range of wireless communication between the electronic subsystems of the Amulet fashion pieces is between one meter and ten meters, and more preferably between two meters and five meters. Such constraints in the maximum range of wireless communication provide an efficient and effective mechanism for social networking between Amulet fashion piece users in a gathering place (such as a bar, restaurant, house or assembly hall) where such users have the capability to meet face-to-face but need not do so for the wireless broadcast exchange of the profile information between the devices and also for the profile matching process that relies on the receipt of such profile information. When the profile matching process matches the two Amulet fashion piece users, the two “matched” users can approach one another for face-to-face communication, if desired. These operations can be repeated for profile matching the user of the Amulet fashion piece to additional Amulet fashion piece users in the gathering place.

The Amulet fashion pieces can be part of a cloud-based system that logs all connections between Amulet devices. For example, the log associated with a particular Amulet fashion piece can store the profile name, public message, and time of meeting for all connections to the particular Amulet fashion piece. Such log data can be used to provide for messaging to such Amulet users (whether they are matched or not). The system can also be configured to allow other Amulet users view the public profile information for other users.

In one embodiment, the Amulet fashion piece includes a core that houses the electrical subsystem, one or more decorative skins that impart style and fashion to the piece, and possible one or one or more bands that allow for different wear configurations of the piece.

In other aspect, the Amulet fashion piece (or intelligent processing similar to that of the Amulet fashion piece) can be configured to connect retail customers to retail products or services. Such functionality can be part of a cloud-based system that logs all connections to the piece or device. For example, the log associated with a particular piece or device can store the profile name, public message, and time of meeting for all connections to the particular piece or device. Such log data can be used to view public information about the retail product or service associated with the connection and foster communication amongst users related to such products or services.

In yet another aspect, the Amulet fashion piece (or intelligent processing similar to that of the Amulet fashion piece) can be configured to connect a user to a group or affiliation of people or an entity. Such functionality can be part of a cloud-based system that logs all connections to the piece or device. For example, the log associated with a particular piece or device can store the profile name, public message, and time of meeting for all connections to the particular piece or device. Such log data can be used to view public information about the group or the entity associated with the connection and foster communication amongst users related to the group or entity.

### BRIEF DESCRIPTION OF THE DRAWINGS

FIG. 1 is a schematic diagram of a system embodying a plurality of Amulet fashion devices that are worn or carried by users to facilitate person-to-person connections.

FIG. 2 is a diagram of exemplary functionality embodied by the components of the system of FIG. 1.

FIG. 3A is a diagram that depicts the housing of a core that is part of an Amulet fashion piece in accordance with an illustrative embodiment of the present application.

FIG. 3B is a diagram that depicts a number of decorative skins or cases that mate to the core housing of FIG. 3A as part of an Amulet fashion piece in accordance with an illustrative embodiment of the present application.

FIG. 3C is a diagram that depicts a number of different bands that can be secured to the core housing of FIG. 3A as part of an Amulet fashion piece in accordance with an illustrative embodiment of the present application.

FIGS. 3D and 3E are diagram that depicts a decorative skin or case that mates to a core housing as part of an Amulet fashion piece in accordance with another illustrative embodiment of the present application.

FIGS. 3F and 3G are opposed side views of the combination skin and core housing of FIGS. 3D and 3E showing a pair of clasps as well as a set of I/O buttons for controlling the electrical subsystem housed within the core.

FIG. 3H is a diagram that depicts a core of an Amulet fashion piece in accordance with yet another illustrative embodiment of the present application.

FIG. 4A is a block diagram of exemplary functionality embodied by the components of the electrical subsystem housed within the core of Amulet fashion piece.

FIG. 4B is a schematic diagram of an exemplary embodiment of a profile exchange and matching process carried out by the electrical subsystem of FIG. 4A in connecting the users of two Amulet fashion pieces.

FIG. 5 is a block diagram illustrating exemplary operations of users of the Amulet fashion pieces and system of FIG. 1.

FIG. 6 is a diagram of an exemplary user interface for registering an Amulet fashion piece with the cloud service of FIG. 1.

FIG. 7 is a diagram of an exemplary user interface for configuring parameters related to profile exchange and matching process of FIG. 4B that is carried out by the electrical subsystem of FIG. 4A in connecting the users of Amulet fashion pieces.

FIGS. 8 and 9 are diagrams of exemplary user interface for presenting connections (or links) that result from the profile exchange and matching process of FIG. 4B that is carried out by the electrical subsystem of FIG. 4A in connecting the users of Amulet fashion pieces and for initiating messaging operations to the users associated with such links.

FIG. 10 is a block diagram illustrating exemplary operations of users of the Amulet fashion pieces and system of FIG. 1 to connect to one another as part of a meet event or game.

FIG. 11 is a schematic diagram of a system embodying a plurality of Amulet fashion devices that are worn or carried by users to facilitate connections between a retail customer user and a retail product or service.

FIG. 12 is a block diagram illustrating exemplary operations of a merchant or vendor in utilizing the Amulet retail communication device of FIG. 11.

FIG. 13 is a block diagram illustrating exemplary operations of retail customer users of the Amulet fashion pieces of FIG. 11.

### DETAILED DESCRIPTION OF THE PREFERRED EMBODIMENTS

Amulet is a fashion piece worn by a user that employs an electronic subsystem that stores profile information for the user in electronic form. The electronic subsystem is also configured to perform a variety of tasks including: i) wirelessly broadcasting the stored profile information over a limited range for wireless communication to other Amulet fashion pieces located within such limited range, ii) carrying out a profile matching process for the profile information that it receives via wireless communication from a respective other Amulet fashion piece located within such limited range, and iii) controlling one or more indicators (such as by activating one or more LED lights and/or mechanical vibrator) in accordance with the results of the profile matching process in order to report such results to the user. The profile matching process is configured to automatically determine if the user of the Amulet fashion piece is likely to be interested in the user of the other Amulet fashion piece. The limited broadcast range of wireless communication of the electronic subsystem of the Amulet fashion pieces dictates the maximum distance between the Amulet fashion pieces for the wireless broadcast of the profile information therebetween and thus limits the profile matching process that relies on the receipt of such profile information. These operations can be repeated for profile matching the user of the Amulet fashion piece to additional Amulet fashion piece users.

In one embodiment, the maximum range of wireless communication between the electronic subsystems of the Amulet fashion pieces is between one meter and ten meters, and more preferably between two meters and five meters. Such constraints in the maximum range of wireless communication provides an efficient and effective mechanism for social networking between Amulet fashion piece users in a gathering place (such as a bar, restaurant, house or assembly hall) where such users have the capability to meet face-to-face but need not do so for the wireless broadcast exchange of the profile information between the devices and also for the profile matching process that relies on the receipt of such profile information. When the profile matching process matches the two Amulet fashion piece users, the two “matched” users can approach one another for face-to-face communication, if desired. These operations can be repeated for profile matching the user of the Amulet fashion piece to additional Amulet fashion piece users in the gathering place.

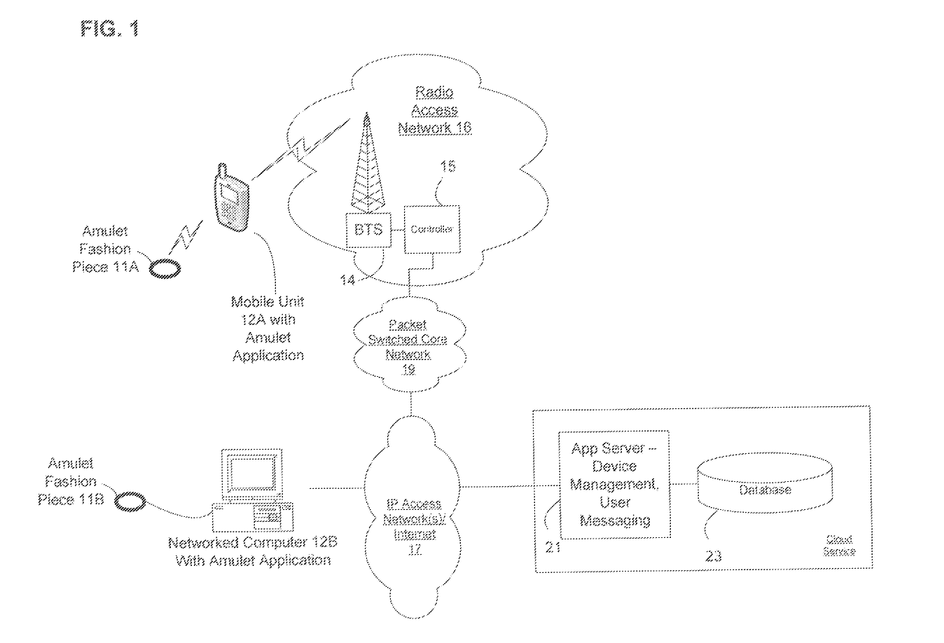

As shown in the system diagram of FIG. 1, the Amulet fashion piece (11A or 11B) includes one or more communication interfaces (such as a wireless Bluetooth interface for the piece 11A and/or a wired USB interface for the piece 11B) that provides for data communication between the Amulet fashion piece and a host computer (mobile unit 12A or networked computer 12B). The host computer executes a software application (hereinafter referred to as “Amulet application” in FIG. 1) that cooperates with a cloud service via networked communications to perform a variety of useful functions. The mobile unit 12A can be any of a number of mobile communication devices including cellular handset devices, personal digital assistants, tablet computers, netbook computers, laptop computers, etc. Such devices typically support wireless communication over a cell-based radio access network 16 that includes base stations and corresponding controllers (one pair shown as 14 and 15) that interface to a packet switched core network 16 which is connected to an IP access network and the Internet 17. The networked computer 12B can be realized by a personal computer, laptop, netbook, tablet, workstation, server, PDA, smartphone or other computing device). The mobile unit 12A and/or the networked computer 12B include software suitable for interacting with the cloud service utilizing networked communication.

The communication network(s) 16, 19, 17 as well as the operating system of the mobile unit 12A and the networked computer 12B can provide support for the TCP/IP networking and suitable messaging protocols in order to communicate messages and/or data between such devices and the cloud service. Those skilled in the art will recognize that the complete structure and operation of communication networks and other components within the system are not depicted or described. Embodiments may be employed in conjunction with known communications networks and other components.

The cloud service of FIG. 1 employs an application server 21 that provides for interaction with the user of the host computer (12A or 12B) to perform the following:
registration of the Amulet fashion piece for association with a particular user;
register and update the profile information for the particular user;
view data pertaining to the profile data uploaded from the Amulet fashion piece of the particular user (see below);
messaging communication with other Amulet users;
arrange meetings with other Amulet users;
access community wide information; and
connect with the Amulet Application executing on the host computer to receive user specific log and profile information and to compute and send updated user specific profile and other information; and
receive customer service and feedback.

Data representing the user profile information, the profile data uploaded from the Amulet fashion piece of the particular user, messages, meetings and community wide information is stored in the database 23. Data representing the user profile information is also stored in the memory of the Amulet fashion device.

The “Amulet application” executed on the host computer (12A or 12B) cooperates with a respective Amulet fashion piece (11A or 11B) over a communication interface therebetween (e.g., a wired USB interface and/or a wireless Bluetooth interface) to perform a variety of functions, such as:
transfer data representing the profile information for a respective user to the Amulet fashion piece for storage in memory of the Amulet fashion piece (a “sync” operation);
upload profile data received from other Amulet fashion pieces and stored by the Amulet fashion piece to the host computer (for example, since last being connected to the host computer); the uploaded profile data (which was received from the other Amulet fashion pieces) can be uploaded from the host computer to the cloud server for storage thereon and access by the registered user of the Amulet fashion piece;
set privacy settings pertaining to the profile information for the respective user; and
update (and possibly restore) software functionality of the Amulet fashion piece.

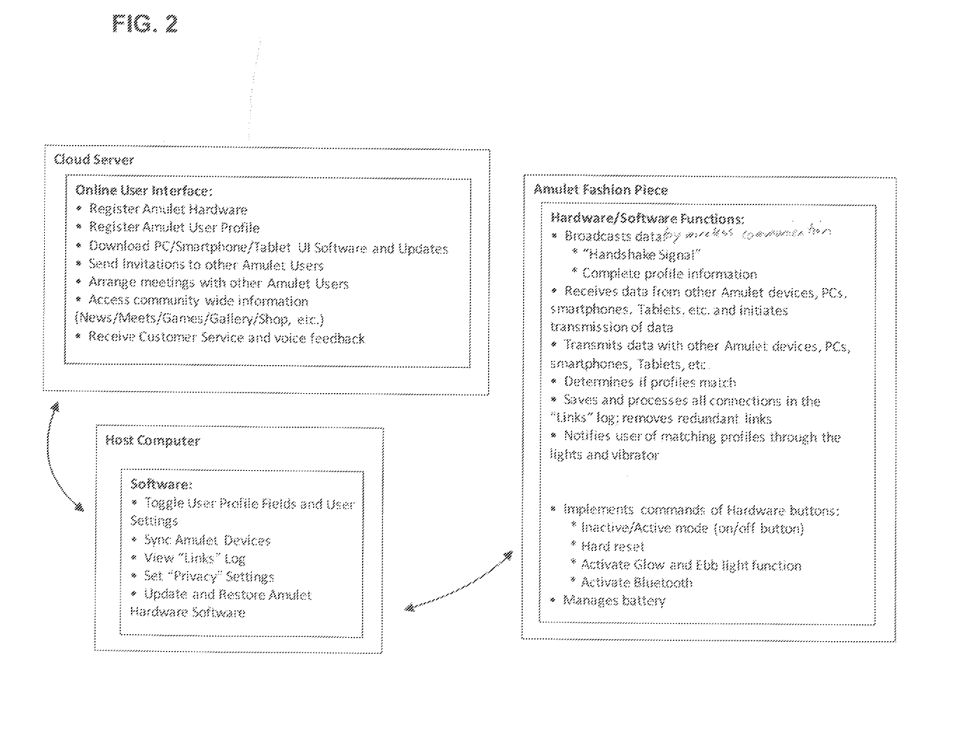

Examples of the functionality embodied by the components of FIG. 1 are shown in FIG. 2.

People use the Amulet fashion piece to express themselves both visually and digitally. The visual expression is conveyed by wearing the Amulet fashion piece (particularly its exterior decorative cases and bands allowing for different wearing configurations) as an article of fashion. The digital expression is conveyed by wireless broadcast of the user's profile information to other Amulet users and by matching their data with other Amulet users. The Amulet fashion piece is a new gateway to the immediate physical world and community, using both fashion and digital networked technology to assist in bringing people together.

The purpose of the Amulet fashion piece and its supporting elements is to inspire people to rekindle their interaction with the real world. So far, the dawn of the information age and social networking has led people to dismember their communication and to isolate themselves in the physical world. The Amulet fashion piece and its supporting elements is intended to bring people back into the public real world, to meet each other, to find their commonalities, to form friendships, and to enjoy our presence together.

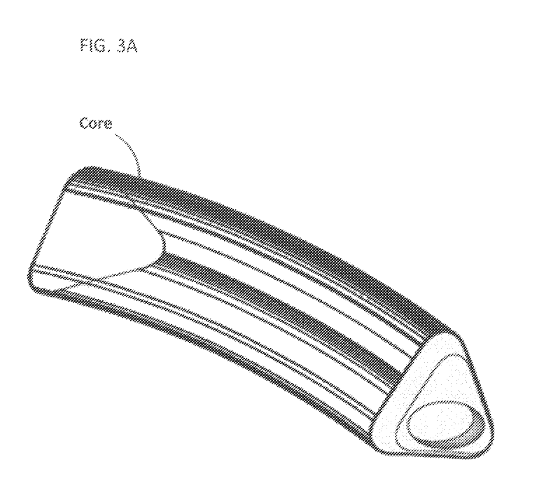

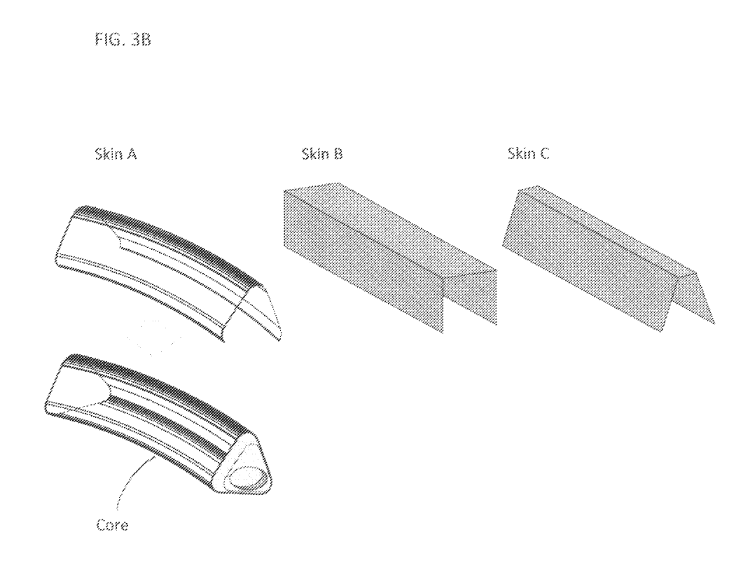

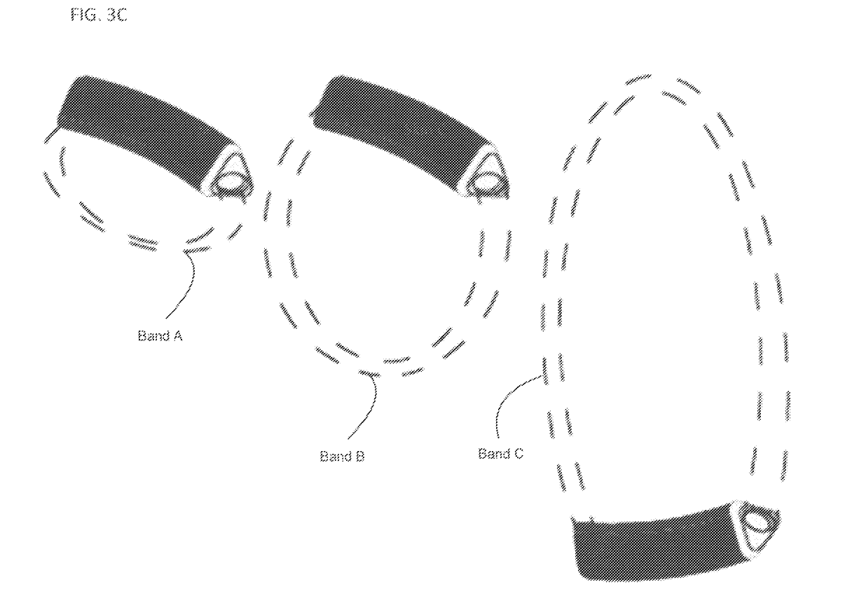

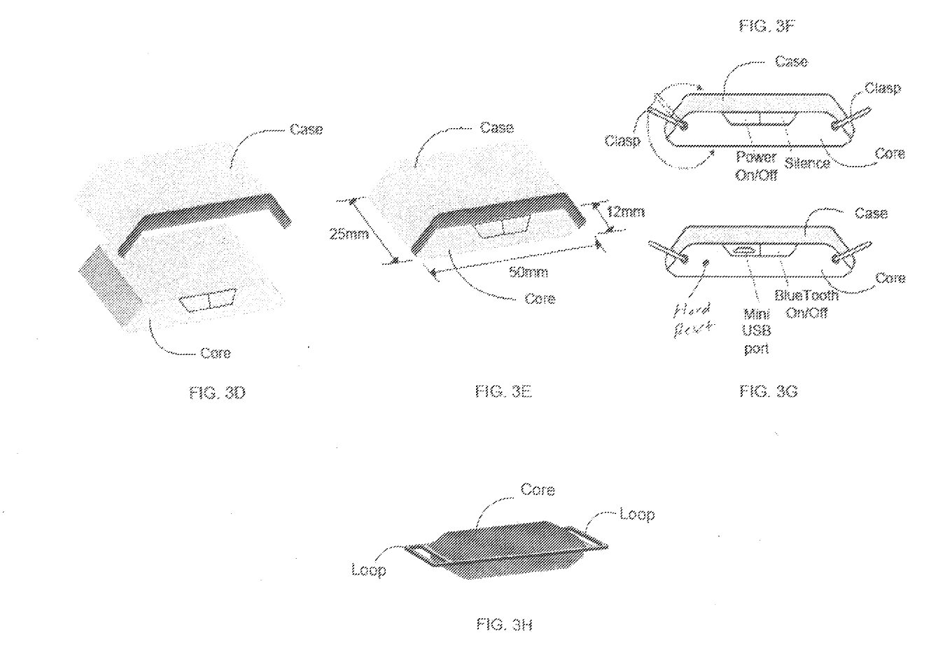

The Amulet fashion piece (11A or 11B of FIG. 1) includes a core, one or more skins, and one or more bands. An exemplary core is shown in FIG. 3A. Exemplary skins are shown in FIG. 3B. Exemplary bands are shown in FIG. 3C.

The core includes a water resistant housing as shown in the exemplary embodiment of FIG. 3A. The housing houses an electrical subsystem (e.g., microprocessor, wireless transceiver for limited range broadcast communication of profile information to other Amulet fashion pieces, communication interface to host computer such as USB and/or Bluetooth interface, battery, and one or more output indicators (LEDs and/or vibrator)) as described below. The skin is a decorative case attached to the outside of the core (for example, by clips or a snap fit or other suitable means) as depicted in the exploded view of FIG. 3B. The decorative nature of the skin can vary for different skins and thus allow the user to express any style and to frequently change their styles by changing the skin. For example, the color, shape, texture, finish, materials and other decorative features of the skin can vary for different skins. Three exemplary skins are shown in FIG. 3B. The band is secured to core and/or to the skin. It provides support for the Amulet fashion piece in one or more wear configurations (i.e., as a ring, as a bracelet, as a necklace, tied to a bag, etc.) as shown in FIG. 3C. The size and shape of the bands can vary for different bands. For example, a wrist-sized band can provide support for the piece where it is worn around the wrist of the user or attached to a bag. A larger band can provide support for the piece where it is worn around the neck of the user. The decorative nature of the band can vary for different bands and thus allow the user to express any style and to frequently change their styles by changing the band. For example, the color, shape, texture, finish, materials and other decorative features of the band can vary for different bands. Exemplary bands are shown in FIG. 3C.

It is also contemplated that the core can function independently without the skin and/or the band. Thus, the core can attach to a bands or another support without the use of a skin.

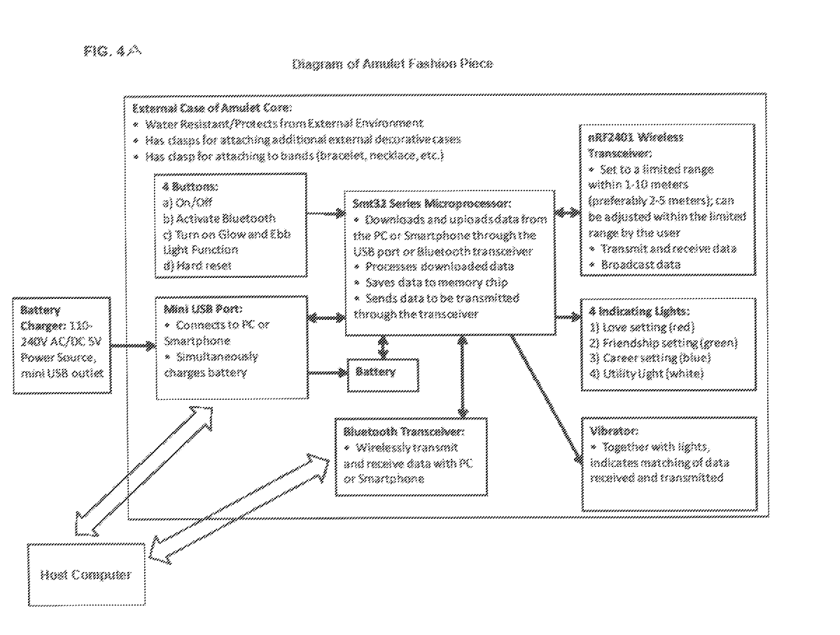

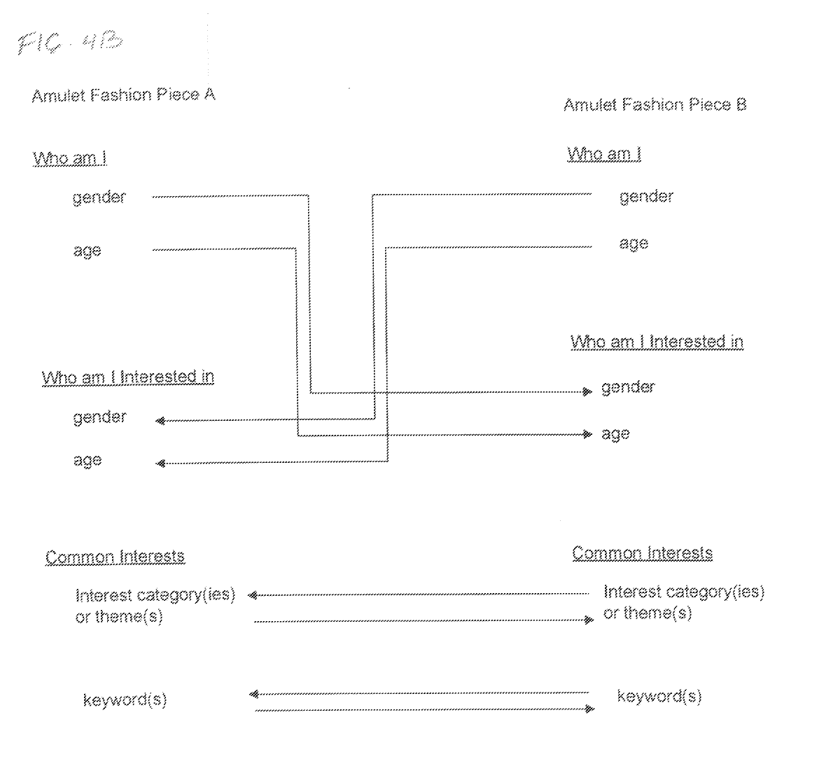

FIGS. 3D to 3G show another illustrative embodiment of the Amulet fashion piece. FIG. 3D shows the core with the removable skin/case separated from the core. The core has a general trapezoidal cross-section, and the skin has three generally planar surfaces that cover the top side and two sides of the core, leaving exposed the bottom and two sides of the core. The core includes indicating lights of different color (red, green, blue, white) that emit light through the top surface of the case when activated. FIG. 3E shows the skin/case secured to the core, along with respective dimensions of the device which includes a length of 50 mm, a width of 25 mm and a thickness (height) of 12 mm. FIGS. 3F and 3G show an exemplary configuration where two pivoting clasps are secured to the two exposed side surfaces of the core. The clasps can be used to secure the device to a band similar to the embodiments of FIG. 3C and thus provides support for the Amulet fashion piece in one or more wear configurations (i.e., as a ring, as a bracelet, as a necklace, tied to a bag, etc.). FIG. 3F also shows a power on/off button and silence button (described in more detail below with respect to FIG. 4) integral to one exposed side surface of the core, while FIG. 3G also shows a mini-USB port, a Bluetooth on/off button and hard reset button (also described in more detail below with respect to FIG. 4) integral to the other exposed side surface of the core.

In another embodiment, the core can be configured with a slot that receives a detachable structure that provides for two opposed closed loops as shown in FIG. 3F. Similar to the clasps of the embodiments of FIGS. 3D and 3E, the closed loops can be used to secure the core (and skin if used) to a band and thus provides support for the Amulet fashion piece in one or more wear configurations (i.e., as a ring, as a bracelet, as a necklace, tied to a bag, etc.).

FIG. 4 is functional diagram of the electrical subsystem of an exemplary core for the Amulet fashion piece 11A or 11B of FIG. 1. The electrical subsystem of the exemplary core includes a microprocessor (for example, a stm32 series microprocessor commercially available from STMicroelectronics of Geneva, Switzerland) with embedded memory for data storage, a wireless transceiver (for example, the nRF2401 wireless radio from Nordic Semiconductor of Oslo, Norway) with associated antenna for broadcast communication of user profile information to other Amulet fashion pieces, a Bluetooth transceiver and associated antenna for interfacing to the host computer via a Bluetooth wireless link, a USB port/power supply circuitry for interfacing to the host computer via a wired USB link and for recharging the rechargeable battery, a four light (RGBW) LED assembly, an electrically controlled vibrator, and four I/O buttons, and a rechargeable battery for powering the electrical components of the core. All of the components of the electrical subsystem of the core (except for the battery) can be mounted on one or more printed circuit boards that are packaged within the core as desired.

It is also contemplated that the microprocessor with embedded memory, the wireless transceiver, and the Bluetooth transceiver of the electrical subsystem can be realized by a system on a chip. For example, the nRF51822 microchip sold commercially by Nordic Semiconductor of Oslo, Norway includes a microprocessor (i.e., a 32-bit ARM Cortex M0 CPU core) with 256 KBytes of flash memory and a multiprotocol transceiver that can be configured for 2.4 GHz ISM band operation for broadcast communication of user profile information to other Amulet fashion pieces as well as for Bluetooth wireless communication for interfacing to the host computer.

The microprocessor functions to download (and upload) data from (and to) the host computer through the USB port or the Bluetooth transceiver. It processes the downloaded data and saves the data to integral memory. It also sends data to be transmitted to other Amulet fashion pieces to the wireless transceiver.

The wireless transceiver preferably employs the 2.4 GHz ISM band for wireless communication to other Amulet fashion pieces. Specifically, the wireless transceiver broadcasts the profile information of the user over a limited distance, which is preferably greater than one meter and less than ten meters, and most preferably between two and five meters. The limited distance is preferably set to a default value, for example on the order of three meters, and can possibly be adjusted by user operation. Such user operation can involve physical interaction with a dial or other element of the Amulet fashion piece or possibly can involve user interaction with an interface embodied by the Amulet application executing on the host computer as described herein in order to specify the desired broadcast distance (maximum range) of the wireless transceiver and subsequent transfer of data specifying the desired broadcast distance (maximum range) of the wireless transceiver from the host computer to the Amulet fashion piece. The wireless transceiver also receives the profile information broadcast from other Amulet fashion pieces. The received profile information (profile data) is transferred to the microprocessor for processing.

The microprocessor carries out the profile matching process for the received profile data supplied by the wireless transceiver and activates the four light (RGBW) LED assembly as well as the vibrator based on the results of the profile matching process.

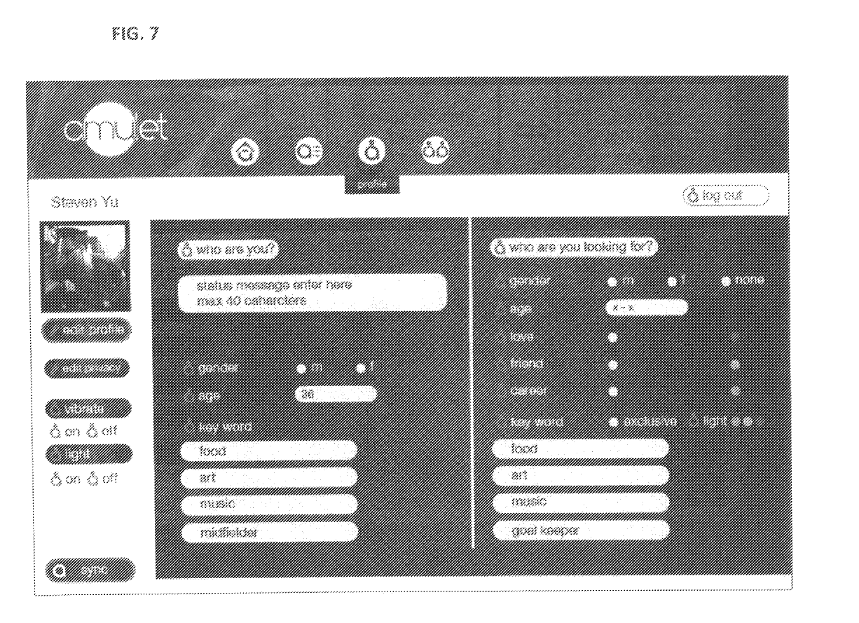

The configuration of the profile matching process as well as the four light (RGBW) LED assembly as a result of the profile matching process is flexible and can be tailored by user input (for example, as described below with respect to FIG. 7) or by design for specific applications.

In one embodiment, the profiles can represent user interest in one or more predefined interest categories (such as a “Love” interest category, a “Friendship” interest category, and a “Career” interest category), and the four light (RGBW) LED assembly can be configured to provide an indication of the results of the profile matching process as follows:

i) the red light of the LED assembly is activated and the vibrator is activated if the profiles match in a predefined interest category (such as the “Love” interest category);

ii) the green light of the LED assembly is activated and the vibrator is activated if the profiles match in another predefined interest category (such as the “Friendship” interest category; and

iii) the blue light of the LED assembly is activated and the vibrator is activated if the profiles match in yet another predefined interest category (such as the “Career” interest category).

The white light of the LED assembly can be used for utility functions. For example, it can be activated when the Amulet fashion piece is successfully synced to the host computer, the battery charge is low, etc.

The four I/O buttons of the electrical subsystem of the core include:

i) an on/off switch;

ii) a switch to activate/deactivate the Bluetooth transceiver;

iii) a silence button to deactivate the LED assembly (only use vibration output to notify user of profile matching results); and

iv) a hard reset switch for resetting the device to an initial/default configuration (this switch can be activated with a pen or other small object to avoid accidental pressing this switch).

The USB port provides a wired USB connection to a host computer and also provides for recharging of the rechargeable battery of the core. Alternatively, a battery charger (for example, a 110-240V AC/DC 5V Power Source) can interface to the USB port to provide for recharging of the rechargeable battery of the core. Alternatively, functionality for wireless charging of the battery of the core can be used.

The operations of the electrical subsystem of the core as described herein can be controlled by a control program executed by the microprocessor. The control program can be embodied as a sequence of instructions and associated data stored as firmware in memory for execution by the microprocessor. The memory of the electrical subsystem is preferably realized by one or more non-volatile embedded memory devices such as ROM, EPROM, or flash memory. It is also contemplated that the electrical system can utilize one or more memory devices that are not embedded as part of the microprocessor.

The core preferably has a waterproof-resistant housing that encloses the electrical components of the core as well as an external skeleton with special clasps for attaching to a respective skin as well as one or more clasps for attaching to a respective band (bracelet, necklace, etc.). An exemplary embodiment for a core with these features is described above with respect to FIGS. 3D-3G

In one embodiment, profile information associated with the user is defined and downloaded from the host computer to the microprocessor and stored in the memory of the microprocessor. Such profile information can include four parts:
user profile information that specifically characterizes the respective user;
profile information describing interests of other Amulet users that the respective user is seeking to meet (referred to herein as an “interest profile”);
optionally, one or more predefined common interest categories or themes that characterize interests of the respective user of the respective Amulet fashion piece that can be shared in common with other users; and
optionally, one or more common interest keywords that characterize interests of the respective user of the respective Amulet fashion piece that can be shared in common with other users.
   Periodically (for example, every 200 ms) or possibly at randomized times, the wireless transceiver broadcasts a “handshake” signal identifying the specific Amulet fashion piece within the limited range of the wireless transceiver. When another Amulet fashion piece detects the “handshake signal”, wireless data communication occurs between the wireless transceivers of the two Amulet fashion pieces wherein such wireless data communication exchanges profile information between the two Amulet fashion pieces. In this wireless data exchange, the profile information broadcast by the wireless transceiver of each respective Amulet fashion piece includes the profile information of the user of the respective Amulet fashion piece and possibly the one or more common interest categories or themes and/or the one or more common interest keywords. The received profile data that is received in conjunction with the wireless data exchange is stored in the memory of the microprocessor of the respective Amulet fashion piece. The microprocessor carries out the profile matching process for the received profile data by matching the received profile data to the stored interest profile that describes interests of other Amulet users that the respective user is seeking to meet and possibly by matching the received profile date to the stored profile information describing the one or more common interest categories or themes and/or the one or more common interest keywords of the user of the respective Amulet fashion piece. The microprocessor activates the four light (RGBW) LED assembly as well as the vibrator based on the results of the profile matching process and the user settings. For example, the color of light can be determined by matching of the predefined categories of in the matching profiles (red light activated for the “Love” interest category shared in the matching profiles, green light activated for the “Friendship” interest category shared in the matching profiles, blue light activated for the “Career” interest category shared in the matching profiles, and user determined activation of lights if the profiles match only on one or more keywords or possibly other matching constraints). After data transmission, one of the Amulet fashion pieces can pause data broadcasting for a brief period to allow other Amulet fashion pieces to connect with the piece that data was just shared with. After two data transmissions without a broadcasting pause, the device can pause its broadcasting to allow other Amulet fashion pieces to transmit data. The received profile data (whether matched or not) can be uploaded to the host computer via the data communication interface therebetween (wired USB link or wireless Bluetooth link), where it can be stored on the host computer (12A or 12B) and uploaded to the cloud service for storage in the database 23 as well as access and presentation to the user by the application server 21. The stored profile data can be cleansed of redundancies and according to privacy settings and then viewed by the user through the interaction between the host computer (12A or 12B) and application server 21 of the cloud service.

As described above, the configuration of the profile matching process as well as the four light (RGBW) LED assembly as a result of the profile matching process is flexible and can be tailored as by the user as desired by the user and/or tailored by the system designer for different applications. For person-to-person matching, one embodiment of the profile matching process employs matching of basic profile information as well as matching of common interest categories or themes as well as matching of keywords as shown in FIG. 4B. In this embodiment, the memory of the Amulet fashion piece stores basic profile information for the user's profile as well as the interest profile that characterizes other users that the user is interested in. For the user's profile, the basic profile information includes a gender (male or female) and an age (an integer in the range 0-110). For the interest profile, the basic profile information includes a gender of interest (male, female, or no preference), and an age range of interest (i.e., 0-110 or blank for no preference). The memory of the Amulet fashion piece can also store one or more categories or themes that characterize interests of the user that can be shared with other users (referred to herein as “common interest categories or themes”). The common interest categories or themes can be predefined, such as an exclusive choice of either a “Love” interest category, a “Friendship” interest category, and a “Career” interest category. Alternatively, the common interest categories or themes can be selected by the user from a predefined list of categories or themes presented to the user. The memory of the Amulet fashion piece can also store one or more keyword(s) that characterize interests of the user that can be shared with other users (referred to herein as “common interest keywords”). The common interest keyword(s) can be arbitrary text as specified by the user or possibly one or more keywords selected from a list of predefined keywords. The basic profile information, the common interest categories and themes and/or the common interest keywords can be derived from information from web-based profiles (such as social network profiles) or surveys or other online activity of the user. The basic profile matching matches the gender and age of the received user profile data to the corresponding gender of interest and age of interest stored in the profile of other users that the user is interested in. The common interest category or theme matching matches the common interest category(ies) or themes of the received profile data to the corresponding common interest category(ies) or themes stored for the user. The keyword matching matches the common interest keyword(s) of the received profile data to the corresponding common interest keywords stored for the user.

The common interest categories or themes can be related to wide variety of topics, such as music, design, food, vacation destinations, etc., each containing a set of objects (i.e., list of songs, collection of new design images, collection of recipes, etc.) that are selected by the user as part of a user profile. The common interest categories or themes can also be refreshed periodically overtime (i.e. monthly, like a magazine). Such refreshing can allow all Amulet users within a language/culture territory to select from the same limited and periodical set of common interest categories or themes in creating their user profiles for matching.

It is contemplated that the common interest categories or themes and their periodic updates will be curated by cloud service, with possible user or other guest suggestions. It is also contemplated that the common interest categories or themes could possibly be sold as advertising space viewed by all Amulet users of associated language/culture territories. The common interest categories or themes can possibly link to web content related to the content's original website so that Amulet users can learn more about the content. The common interest categories or themes can also refer to web content related to a retail user that belongs to the Amulet cloud service or with Amulet cloud service acting as a referrer possibly with commission.

The common interest matching and the keyword matching can be strict and require exact matching. For example, a common keyword interest of “soccer” shared by the Amulet fashion pieces A and B generates a match, while a common keyword interest of “soccer” stored by the Amulet fashion piece A does not the match the common keyword interest of “futbol” stored by the Amulet fashion piece B. Alternatively, rule based matching analysis or other suitable statistical matching analysis can be used to provide equivalency matching of the profile data as deemed appropriate. In this case, the common keyword interest of “soccer” stored by the Amulet fashion piece A can be determined to match the common keyword interest of “futbol” stored by the Amulet fashion piece B.

Other profile matching schemes can be used. For example, the user profiles can employ categories and/or keywords with scores to denote common interests and rule-based analysis can be used to provide equivalency matching of the profile data. An example of this scenario is the matching of profile data for a player of a particular game (such as “World of Warcraft”) with a high score of 57 is matched to the profile for a player of the particular game (“World of Warcraft”) with a high score of 58. In another example, the profile data can include certain interest categories (such career, relationships, outgoing) and associated scores and rule-based analysis can be used to provide equivalency matching of the profile data. In other examples, the profile data can be represented by a set of objects or items and the matching logic determined if the sets match in some desired way.

The keyword searching (and possibly other parts of the profile matching process) can be optional and included as part of the process by the user. Moreover, the user input can assign the visual indicator lights to particular parts of the matching process such that the successful matching of the particular part activates the corresponding visual indicator light assigned thereto.

The system of FIG. 1 combines communication technologies including social networking and wireless data transmission with visual aesthetic self-expression—fashion. The Amulet fashion piece is a new tool for a self-expression that goes both beyond an anonymous internet social network profile and host computer application as well as way beyond an unintelligent fashion accessory that does not have the capability to inform others about the person wearing the accessory.

The system of FIG. 1 also has many unique features.

For example, the Amulet fashion piece has an aesthetic design and style of an article of jewelry.

In other example, the Amulet fashion piece employs short range wireless transmission of user profile data preferably within a range greater than one meter and less than ten meters (more preferably within a range of two to five meters).

In yet another example, the Amulet fashion piece is configured to become more aware, to initiate communication, and to form relationships of the people already in one's presence. The idea is that it is very likely that the users have already mutually acknowledged each other's existence, and as they move closer physically to within the wireless communication range of the Amulet fashion piece, they can discover the things that they might have in common. This is in contrast to a device that connects people in a very large range where users only know of each other's presence from using the device or application and lack other methods of learning about the other user (most importantly immediate and present observation and interaction).

In yet another example, the system employs a user interface and profile field settings using a basic exact field setting match to connect people.

In another example, the user profile information exchanged and matched by Amulet fashion pieces is designed specifically for meeting people in the real world and using digital resources and wireless data transmission technology to enhance real world immediate interactions. The user profile allows for users to determine exactly how they want to express themselves. Users can choose how general or specific their interests are and how broadly or narrowly they want to connect to other people through the system.

The Amulet fashion piece also employs a simple intuitive hardware user experience where the device gently and organically notifies you that there is a matching profile in range. There is no other additional content information that competes for the user's attention (now the scarcest resource). There are no other notifications that compete with each other.

In another example, the system allows Amulet users to create a public profile. The public profile can be user-customizable (and thus can be as specific or as general as desired by the user—which allows the user to define how the user wants other people to know the user).

Furthermore, the system allows a respective Amulet user to create a profile of the person that the respective Amulet user would like to meet, which is referred to as an “interest” profile herein. The interest profile can be user-customizable (and thus can be as specific or as general as desired by the user—which allows the user to define what kind of person you want to connect to in your social life). The interest profile can include one or more predefined interest categories, such as a “Love” interest category, “Friendship” interest category, “Career” interest category. The interest profile can also employ one or more keywords specified by the user for identifying arbitrary interest(s) of the user.

The Amulet fashion piece is worn by a user with the user's profile information stored therein, and it operates to wirelessly broadcast the user's profile to others in a limited range that use an Amulet fashion piece in order to connect with the people and the environment in short range proximity to the user (which could be people, products, places, brands, anything with an associated amulet profile).

The Amulet fashion piece allows a user to publicly broadcast a message and express oneself to a community of people that the user can actually see and immediately interact with, and use this public message to attract invitations to start forming relationships with the people that the user shares an immediate environment with.

The Amulet fashion piece also provides notification if another Amulet user who is in the limited range of the device matches the user's interest profile (i.e., the profile of the person that the user would like to meet). Such notification can be used for social networking and can allow the user to begin face-to-face interaction with the matched user, if desired.

The system can be configured to log all connections with profile name, public message, and time of meeting and allow for messaging with such Amulet users, whether they are matched or not. This feature can be useful to identify the people who you pass by and brush shoulders with the user, which can be a much different group than friends or followers on traditional social networking systems such as Facebook and Twitter. The system can be configured to allow other Amulet users view the public profile information for other users (including those referenced in the connection log). The public profile information can be limited to only that information that the respective user defines as relevant to such other users and that the respective user wants to share to other Amulet users. The public profile information can be derived from social network profiles and activities and/or other online activity (such as the articles you read in the last month or week, articles you commented on or ranked, ad click-throughs, search queries, etc.)

The system can also be configured to invite and set up a meeting with other Amulet users on your log. This feature can be useful to initiate real life connections with the people who you share an immediate environment and common interests with through a safe and private platform.

The system preferably employs privacy settings that allow a respective user to protect oneself from profiles with content you specify as not wanting to be exposed to. This feature can be used to meet people in an environment that the user feels safe and comfortable in.

The system can also be configured to allow users to create and join games where the users connect interactively with communities of Amulet users sharing common interests, as simple as meeting a group of people wanting to expand their friendships in their local area at the local book store or bar, or a more specific interest group with more customized profiles aimed at expressing oneself within a shared interest (also a way to connect with communities who share an interest in participating brands and products).

The Amulet fashion piece expresses the user's sense of style and desire to socially connect to other users. The Amulet fashion piece can be accompanied by an array of beautiful cases and accessories for many different ways of wearing and displaying the Amulet fashion piece.

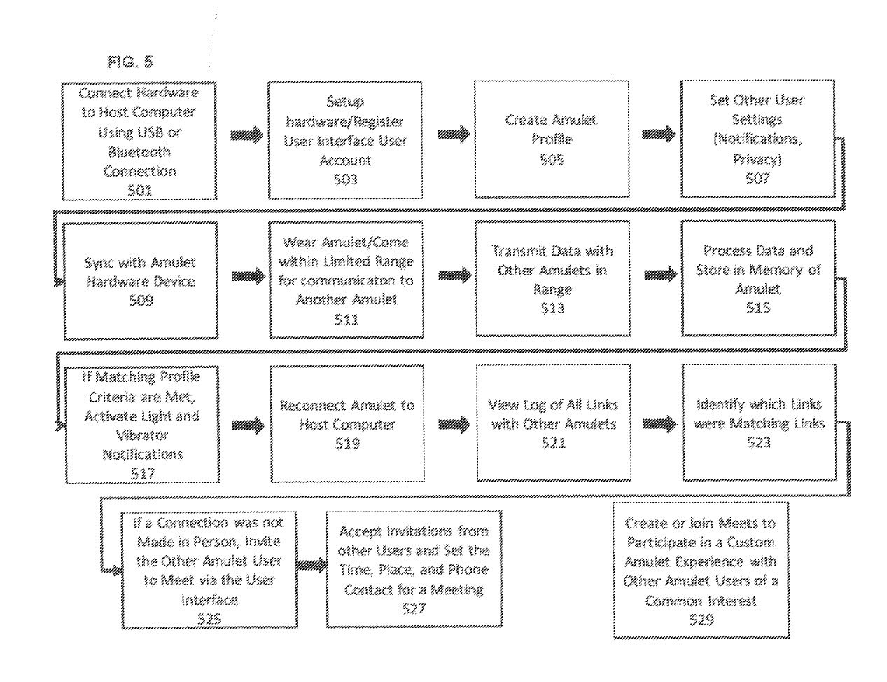

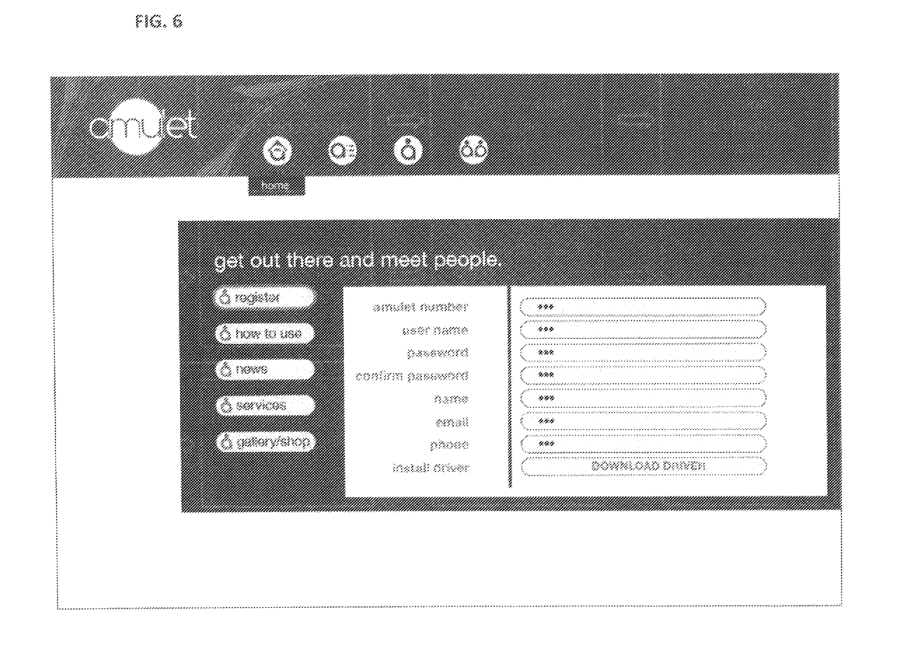

FIG. 5 is a step-by-step description of exemplary operations in using the Amulet fashion piece of FIG. 1.

In block 501, the user connects the core of the Amulet fashion piece (11A or 11B) to the host computer (12A or 12B) by the data communication interface therebetween (such as a wired USB link or a wireless Bluetooth link).

In block 503, the user executes the Amulet application executing on the host computer to interact with the application server 21 of the cloud service. In this block, the user registers the hardware (the user's Amulet fashion piece) and sets up a user account. This can involve the following:
user enters the unique serial number on the hardware.
user creates and enters a username for their profile name.
user creates and enters a password to access their online user account.
user enters their real name for identity verification.
user enters their email address.
user enters their phone number.
user installs the software driver on the host computer system (where the software driver can correspond to the operating system of the host computer system).

An example of a user interface presented to the user of the Amulet application executing on the host processor during block 503 is shown in FIG. 6.

In block 505, the user executes the Amulet application executing on the host computer to interact with the application server 21 of the cloud service to define user profile information for the user. Alternatively, the Amulet application executing on the host computer alone (without the cooperation of the application server 21) can be used to define user profile information for the user. In one embodiment, such user profile information can include the following:
information pertaining to the user—“Who I am—user specific profile information”—such as a status message with a maximum of 40 characters, gender of the user (male or female), and age of the user (integer in range 0-110);
information pertaining to other Amulet users who the user is seeking—“Who I am looking for—interest profile information”—such as a gender choice (male, female, or no preference), an age range (i.e., 0-110 or blank for no preference)
information pertaining to one or more common interest categories or themes (such as an exclusive choice of either a “Love” interest category, a “Friendship” interest category, and a “Career” interest category); and
information pertaining to one to four common interest keywords, where each common interest keyword is defined by arbitrary text specified by user input and has a maximum of 40 characters (if this option is selected, the user chooses a light color for notification when data matches during use of the hardware).
   An example of a user interface presented to the user of the Amulet application executing on the host processor during block 505 is shown in FIG. 7. The user profile information can include a wide variety of user information not shown in FIG. 7. It is possible that the user profile information can be derived from user input data from another source (i.e. another website with a user profile feature, such as a social networking site such as Facebook.com). For example, such user input data can be converted or organized into a data form suitable for integration into the user profile information. This could involve algorithms or other functions that translate and convert data into other forms.

In block 507, the user executes the Amulet application executing on the host computer to interact with the application server 21 of the cloud service to define other settings for the user. Such other settings can include the following:
user I/O settings, which can allow the user to set the vibrate and light functions of the Amulet fashion piece (for example, information specifying the strength of vibration as a result of the matching process (if any), information specifying which lights are activated as a result of the matching process (if any), and information specifying the pattern of the light activation as a result of the matching process (if any)), and control whether or not the electrical subsystem of the Amulet fashion piece can continue to broadcast, receive, and process data from other hardware devices without disturbing the user; and
user privacy settings and filters, which allows the use to set privacy and filter settings that operate to filter all content from other users that fit set content categories (i.e. sex, illegal substances, obscene language, etc.). This information is filtered through the operation of the software logic executing on the host computer and/or the application server of the cloud server and thus is unrelated to the functioning of the core device of the Amulet fashion piece.

In block 509, if not done so already, the user connects the Amulet fashion piece to host computer by a data communication interface (i.e., the wired USB link or wireless Bluetooth link) between the host computer and the core of the Amulet fashion piece. The user executes the Amulet application executing on the host computer to transfer (sync) the user profile information to the core of the Amulet fashion piece for storage in the memory of the microprocessor of the core of the Amulet fashion piece. In one embodiment, the transfer is initiated by the user pressing a “Sync” button presented to the user by the Amulet application executing on the host computer as shown in FIG. 7. The user profile information is transferred over the data communication interface (i.e., the wired USB link or wireless Bluetooth link) between the host computer and the core of the Amulet fashion piece.

In block 511, the user disconnects the Amulet fashion piece from the host computer and wears the Amulet fashion piece and comes within a limited communication range of other Amulet fashion pieces. The limited communication range is dictated by the wireless communication range of the wireless transceiver of the core of the respective Amulet fashion pieces. In one embodiment, such wireless communication range encompasses a maximum distance between one and ten meters (preferably, it encompasses a maximum distance between three and five meters).

In block 513, the core of the Amulet fashion piece exchanges user profile information with another Amulet fashion piece that is detected within the limited communication range of the Amulet fashion pieces.

In block 515, the respective Amulet fashion piece saves the profile data received from the other Amulet fashion piece that is detected within the limited communication range of the Amulet fashion pieces. Such profile data is stored in the memory of the microprocessor of the core of the respective Amulet fashion piece. It also carries out the profile matching process for the received profile data by matching the received profile data to the stored profile information describing interests of other Amulet users that the respective user is seeking to meet as well as the common interest profile data of the respective user as described above with respect to FIG. 4B.

As part of the profile matching process of block 515, the gender of the received profile data is compared to the gender selection of the stored “who I am looking for” profile information to determine a match therebetween. For example, if the gender selection of the stored “who I am looking for” profile information is set to a female gender and the gender of the received profile data is a male gender, the gendering criterion do not match. In another example, if the gender selection of the stored “who I am looking for” profile information is set to a female gender and the gender of the received profile data is a female gender, the gendering criterion match. In yet another example, if the gender selection of the stored “who I am looking for” profile information is set to “no-preference” and the gender of the received profile data is a male or female gender, the gender criterion match.

As part of the profile matching process of block 515, the age of the received profile data is compared to the age range of the stored “who I am looking for” profile information to determine a match therebetween. If the age range of the stored “who I am looking for” is left blank, then there are no age restrictions for that user's age criterion and the age criterion matches in all cases.

As part of the profile matching process of block 515, the predefined common interest category or theme of the received profile data is compared to the predefined common interest category or theme of the respective user to determine a match therebetween. For matching common interest category, As part of the profile matching process of block 515, the common interest keyword(s) of the received profile data is(are) compared to the common interest keyword(s) of the respective user to determine a match therebetween.

The common interest matching and the keyword matching of can be strict and require exact matching. For example, the common interest matching can require that both users share the same common interest category of “Love”, “Friendship” or “Career”. Alternatively, rule based matching analysis or other suitable statistical matching analysis can be used to provide equivalency matching of the profile data as deemed appropriate.

In one embodiment, the received profile data is determined to match the stored profile data of the respective user in step 515 when the gender criterion, the age criterion, the common interest category or theme matching criterion and the common interest keyword matching criterion are all met. In alternate embodiments, different profile information and matching criterion can be used to determine matching profiles between users.

In block 517, the microprocessor activates the four light (RGBW) LED assembly as well as the vibrator based on the results of the profile matching process of block 515 and the user settings. The light(s) and/or vibrator can be activated for a limited duration (such as for a few seconds). In one example, the color of light activated in block 517 is determined by the category of matching profile (red for “Love”, green for “Friendship”, blue for “Career”, and user determined if based only on keyword match). The Amulet fashion piece maintains a connection log in its memory. The microprocessor stores the received profile data (whether matched or not) and data representing the results of the matching process in the connection log. In this manner, the connection log stores the received profile data (whether matched or not) and data representing the results of the matching process for a number of Amulet fashion piece users that are matched to the user of the respective Amulet fashion piece.

After data transmission, one of the devices can pause data broadcasting for a brief period to allow other Amulet fashion pieces to connect with the Amulet fashion piece that data was just shared with. After two data transmissions without a broadcasting pause, the device can pause its broadcasting to allow other Amulet fashion pieces to transmit data.

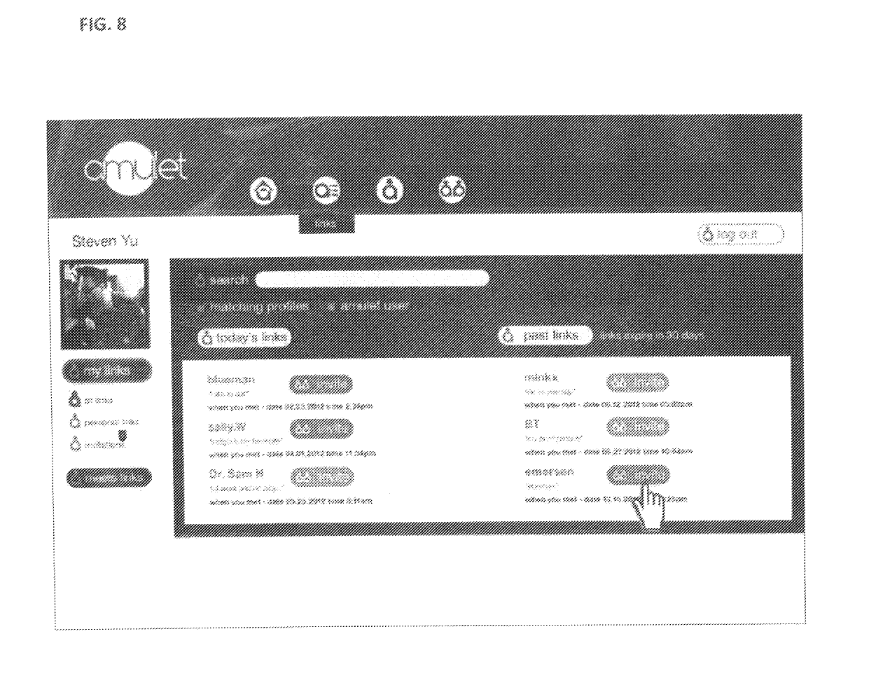

In block 519, the user reconnects the Amulet fashion piece to host computer by the data communication interface (i.e., the wired USB link or wireless Bluetooth link) between the host computer and the core of the Amulet fashion piece. The user executes the Amulet application executing on the host computer to upload to the connection log to the host computer via the data communication interface therebetween. The connection log (and/or the profile data stored therein) can be uploaded from the host computer to the cloud service for storage in the database of the cloud service as well as for access and presentation to the user by the application server of the cloud service. Such profile data can be cleansed of redundancies and filtered according to privacy settings and then viewed by the user through the interaction between the host computer and the application server of the cloud service. For example, the user can access the “My Links” section through their account on the user interface presented to the user by the application server. The “All Links” section of “My Links” displays a table that shows the Username, Public Status Message, and Date and Time of encounter of all Amulet fashion pieces that exchanged profile information with the user's Amulet fashion piece as illustrated in FIG. 8 below. The users whose profile data satisfied all matching profile criteria will be highlighted. The sharing of additional profile information amongst users (even amongst matching users) can be limited, such as to only the Username, Public Status Message, and Date and Time of encounter. The “Personal Links” section displays a table that shows the Username, Public Status Message, and Date and Time of encounter of all Amulet fashion pieces with matching profiles. It is possible for the user to access and view the connection log (and/or the profile data stored therein, such as the All links and My Links displays of FIG. 8) without connecting to the cloud service.

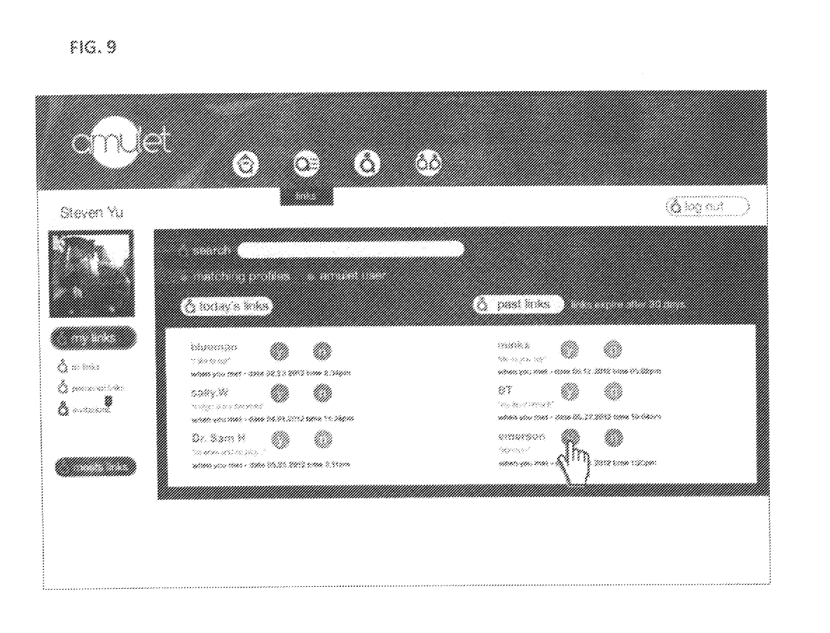

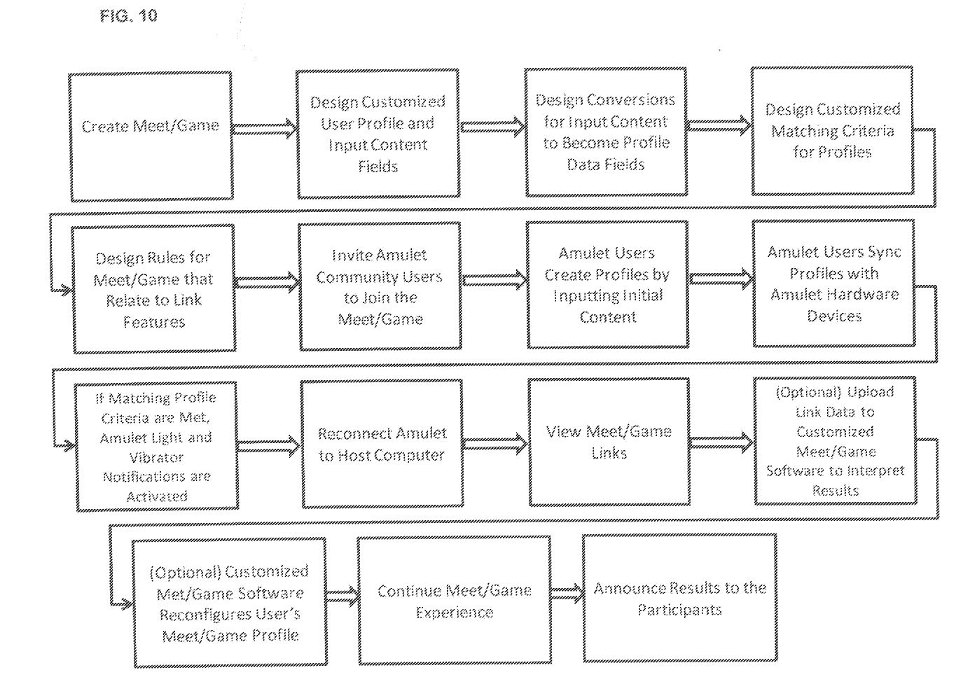

For both the “My Links” and “Personal Links” section, an “Invite” button can be associated with each link as shown in FIG. 8. The “Invite” button allows the user to contact other users by messaging and facilitate meeting through the user interface. When the user clicks the “Invite” button, an invitation message will be sent to the other user. The Invitations section provides the user with the option of accepting an invitation, ignoring the invitation, or rejecting the invitation as shown in FIG. 9.

An accepted invitation will generate several fields for the user to propose a time and place to meet, as well as a telephone number to facilitate the meeting. An ignored invitation will be as if the invite button were never presses. Two ignored invitations constitute a rejected invitation. A rejected invitation will remove the link from both users' “My Links” log.

The connection logs (and the data contained therein) can be used to track, record, and potentially later analyze information about who encounters who, at what time, and people who seek out to form relationships with one another after their immediate encounter.

The Amulet community is not formed solely by users, but also by their lives in the concrete world. They are people with common interests that were independently self-defined. They are people who actually shared presence in the concrete world. The connection log and the profile data contained therein and related messaging can also be used for other applications and games.

For example, the system of FIG. 1 as described above can be arranged to provide for communication between participants of a specific event. This is referred to below as a meet or game or meets/games. In this application, the user profiles and matching criteria carried out by the profile matching process of the Amulet fashion pieces of the participants of the event are designed specifically for the event.

An example of the use of the system of FIG. 1 for meets/games is shown in FIG. 10. Input content for the profile can come from any information source. The input can be processed in flexible manners to generate user profiles. The user profiles can have customized rules for determining matching criteria. The data will still be processed in the same manner by the hardware when there is a data transmission between Amulet fashion pieces in range.

An example of a game designed for an Amulet fashion piece might be as follows. Associates gather information about a user from other social networking websites and input the information into the customized profile of the Amulet application or game. The software converts the input content into a profile for the user, without the user ever having seen the original input content. The user downloads the profile onto his/her Amulet fashion piece and goes out to see which profiles he/she matches with.

This would allow for one's friends or associates to determine the potential for a user to create social connections without the user's input, potentially exposing them to a very different set of profiles than what they might encounter if they determined their own profile information.

Another example of a game using the “My Links” function might be as follows. A large corporation designs a customized profile and invites their members to participate. There is a rule where the winner of the “game” is the first person who links up with x number of a specific type of profile/matching profiles, etc. The “My Links” feature allows for the rule that determines the winner.

It is contemplated that in certain applications, such as the games described above with respect to FIG. 10, the profile information for the user and stored in the memory of Amulet fashion piece can be dynamically updated by the microprocessor based upon certain conditions, which can be derived from inputs from the data exchange and/or the connection log. One example would be a “human v. zombie” tag game where the profile information for given user initially indicates the given user is human (“H”). The profile information is dynamically updated to automatically change to a zombie designation (“Z”) after connecting to another Amulet device user with a zombie designation (“Z”). Note that this change of the user profile data does not require connecting with the host device or the cloud server.

It is also contemplated that companies and other organizations can also set up meetings and events similar to that described above with respect to FIG. 10 for commercial, recreational, or other purposes.

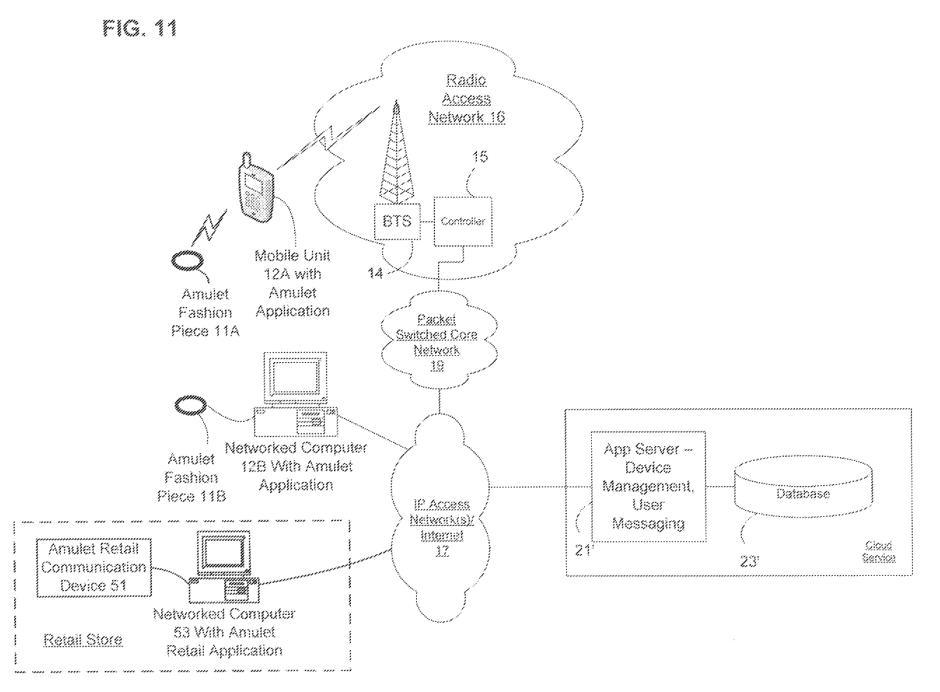

FIG. 11 illustrates another aspect of the present application where the functionality of the Amulet piece and associated elements as described above are adapted to connect retail customers to merchants and to foster communication between the merchants and the retail customers. A retail customer wears or carries an Amulet fashion piece (11A or 11B) that stores customer profile information for the retail customer. Such customer profile information is similar in some regards to the user profile information stored by the Amulet fashion piece of FIG. 1. For example, the customer profile information can include a username, gender, age, location, and occupation of the customer. The customer profile information can also include information related to goods or services of interest to the customer. For example, the customer profile information can include brand names or other product attributes that are of interest to the customer. The customer profile information can also include other information related to the customer, such as references to media items (e.g., audio tracks, movies, tv shows, books, magazines, newspapers, periodicals) that are of interest to the customer or references to cultural references (e.g., performance genres, trends, artists, artistic works, etc.) that are of interest to the customer.

A retail store employs an Amulet retail connection device 51 located within the retail space of the store. The device 51 includes the basic functionality of the core of the Amulet piece as described above (e.g., a microprocessor with embedded memory for data storage, a wireless transceiver for wireless data broadcast communication to Amulet fashion pieces of retail customers that are located within the limited communication range of the wireless transceiver, and a data communication interface (such as wired USB interface or a wireless Bluetooth interface) for interfacing to a host computer. The device 51 can be powered by mains power via an AC/DC adapter as is well known in the electronic arts. Alternatively, the device 51 can also be powered by a rechargeable battery or other suitable power supply means. The microprocessor memory of the device 51 stores merchant profile information that relates to the goods and/or services sold by the merchant in the retail store. Such merchant profile information can include brand names and/or other product attributes regarding the goods and/or services sold by the merchant in the retail store. The stored merchant profile information can be specific to goods or other information that is located at or near the device 51. In this manner, the device can be part of a retail space tailored for a specific brand or product. The device 51 wirelessly broadcasts the stored merchant profile information over a limited communication range (which is preferably on the order of 1 to 10 meters, and more preferably on the order of 2 to 5 meters) for wireless communication to one or more Amulet fashion pieces located within such limited range. The Amulet fashion piece of the customer can also wirelessly broadcast its stored customer profile information over a limited communication range (which is preferably on the order of 1 to 10 meters, and more preferably on the order of 2 to 5 meters) for wireless communication to the device 51. The device 51 receives the customer profile information via wireless communication from the Amulet fashion pieces (such profile information is hereinafter referred to as a “customer profile link”). The Amulet fashion piece carries out a profile matching process for the merchant profile information that it receives via wireless communication from the device 51 (such profile information is hereinafter referred to as a “merchant profile link”) located within such limited range. The Amulet fashion piece reports the results of the profile matching process to the customer via one or more output devices (such as by activating an LED light and/or mechanical vibrator) in accordance with the result of the profile matching process.

As shown in the system diagram of FIG. 11, the Amulet fashion piece (11A or 11B) includes one or more communication interfaces (such as a wireless Bluetooth interface for the piece 11A and/or a wired USB interface for the piece 11B) that provides for data communication between the Amulet fashion piece and a host computer (mobile unit 12A or networked computer 12B). The host computer executes a software application (hereinafter referred to as “Amulet application” in FIG. 11) that cooperates with a cloud service via networked communications to perform a variety of useful functions. The mobile unit 12A can be any of a number of mobile communication devices including cellular handset devices, personal digital assistants, tablet computers, netbook computers, laptop computers, etc. Such devices typically support wireless communication over a cell-based radio access network 16 that includes base stations and corresponding controllers (one pair shown as 14 and 15) that interface to a packet switched core network 16 which is connected to an IP access network and the Internet 17. The networked computer 12B can be realized by a personal computer, laptop, netbook, tablet, workstation, server, PDA, smartphone or other computing device). The mobile unit 12A and/or the networked computer 12B include software suitable for interacting with the cloud service utilizing networked communication.

The device 51 includes one or more communication interfaces (such as a wired USB interface and/or wireless Bluetooth interface) that provides for data communication between the device 51 and a host computer 53. The host computer executes a software application (hereinafter referred to as “Amulet retail application” in FIG. 11) that cooperates with a cloud service via networked communications to perform a variety of useful functions. The host computer 53 can be realized by a personal computer, laptop, netbook, tablet, workstation, server, PDA, smartphone or other computing device). The host computer 53 includes software suitable for interacting with the cloud service utilizing networked communication.

The communication network(s) 16, 19, 17 as well as the operating system of the mobile unit 12A, the networked computer 12B and the host computer 53 can provide support for the TCP/IP networking and suitable messaging protocols in order communicate messages and/or data between such devices and the cloud service. Those skilled in the art will recognize that the complete structure and operation of communication networks and other components within the system are not depicted or described. Embodiments may be employed in conjunction with known communications networks and other components.

The cloud service of FIG. 11 employs an application server 21′ that provides for interaction with the user of the Amulet retail application executing on the host computer 53 to perform the following:
registration of the merchant as part of the cloud service;
define (and update) merchant profile information that relates to the goods and/or services sold by the merchant in the retail store; such merchant profile information can include brand names and/or other product attributes regarding the goods and/or services sold by the merchant in the retail store as well as interest categories or themes or keywords that can be shared with customer Amulet users for matching; and
define (and update) links to other information portals related to the goods and/or services sold by the merchant in the retail store; such information portals can be a brand/product website, Facebook fan page, online shop, product information, blog, etc.)

The Amulet retail application executing on the host computer 53 cooperates with a respective device 51 over a communication interface therebetween (e.g., a wired USB interface and/or a wireless Bluetooth interface) to perform a variety of functions, such as:
transfer data representing the merchant profile information to the device 51 for storage in memory of the device 51 (a “sync” operation);
upload data pertaining to “customer profile links” as stored by the device 51 to the host computer 53; the uploaded data pertaining to the “customer profile links” can be uploaded from the host computer 53 to the cloud service for storage thereon and access by the merchant (see below); and
update (and possibly restore) software functionality of the device 51.

The functionality of the Amulet retail application and cloud service enables the registered merchant to initiate a new way of engaging and interacting with customers in a real world context. Specifically, it enables real people to share who they are and what they like with the retailer based on their direct interaction with the product in a retail setting. It also enables the retailer to share with “interested” customer information regarding the goods and/or services that the customer is interested in.

The application server 21′ of the cloud service of FIG. 11 also provides for interaction with the user of the Amulet application executing on the host computers (12A or 12B) of the Amulet fashion pieces to perform the following:
registration of the amulet fashion piece;
register and update the profile information for the user (retail customer);
view data pertaining to the “merchant profile links” (such as a log of merchant profile links) uploaded from the Amulet fashion piece of the user (see below);
messaging communication to other customers and merchants;
arrange meetings with merchants;
access community wide information; and
receive customer service and feedback.

Alternatively, the Amulet application executing on the host computers (12A or 12B) can provide such functionality without cooperation of the application server 21′. Data representing the user profile information, “merchant profile links,” messages, meetings and community wide information is stored in the database 23′ of the cloud service.

The Amulet application executed on the host computer (12A or 12B) cooperates with a respective Amulet fashion piece (11A or 11B) over a communication interface therebetween (e.g., a wired USB interface and/or a wireless Bluetooth interface) to perform a variety of functions, such as:
transfer data representing the customer profile information to the Amulet fashion piece for storage in memory of the Amulet fashion piece (a “sync” operation);
upload data pertaining to “merchant profile links” as stored by the Amulet fashion piece to the host computer (for example, since last being connected to the host computer); the uploaded data pertaining to the “merchant profiled links” stored on the Amulet fashion piece can be uploaded from the host computer to the cloud server for storage thereon and access by the registered user of the Amulet fashion piece;
set privacy settings pertaining to the customer profile information for the user; and
update (and possibly restore) software functionality of the Amulet fashion piece.

The functionality of the Amulet application and the cloud service allow the registered customer to become part of a community of real people communicating with merchants of goods and/or services and with one another, particularly for brands or other product attributes that the customer is interested in. Such functionality can transform the shopping experience into a social experience where one can meet new acquaintances and become part of a community. Such functionality also allows the customer to share and receive recommendations for goods and services from merchants as well as other customers.

The customer profile information maintained in the database of the cloud service can be used to find particular goods and/or services that match the interests of the customer, and/or to find and connect to other customers who match the interests of a respective customer. The stored customer profile information can also be used to initiate a group activity for people and possibly retailers that share similar interests. The stored customer profile information can be updated and refined based on the attributes of the products that the customer is interested in.

The functionality of the Amulet application and cloud service also allows the registered customer to set privacy settings that dictate what and how the customer profile information is shared with merchants and/or other retail customer users.

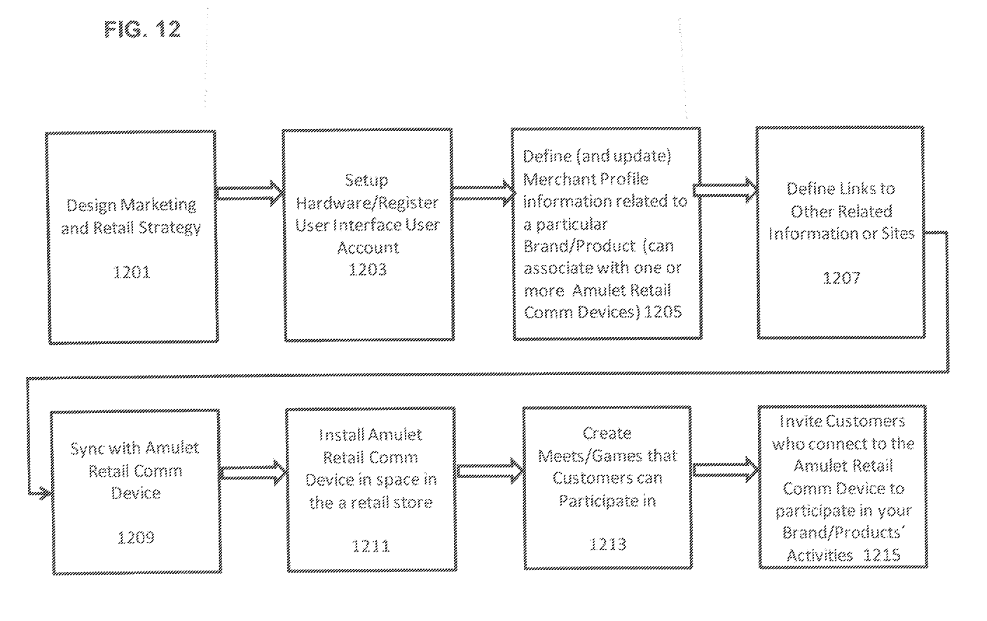

FIG. 12 is a step-by-step description of exemplary operations of Merchants using the system of FIG. 11.

In block 1201, a merchant designs a marketing and retail strategy for goods and/or services sold by the merchant. Such goods or services can be a brand and/or product.

In block 1203, the merchant executes the Amulet retail application executing on the host computer 53 to interact with the application server 21′ of the cloud service. In this block, the merchant registers the hardware (one or more devices 51) and sets up a merchant.

In block 1205, the merchant executes the Amulet retail application executing on the host computer 53 to interact with the application server 21′ of the cloud service to define 9 and possibly update) merchant profile information relating to the goods and services of the merchant. The merchant profile information can be based upon the marketing and retail strategy designed in block 1201. Also it can be tailored for particular brand /product and possibly associated with one or more particular device 51 for communicating brand/product specific from the particular device(s). The merchant profile information can include the following:
Gender for the brand/product (Male, female, or no preference)
Age range for a brand product
a limited number of free entry text boxes specifying media/culture textual references that is indicative of the mood and/or style of the particular brand/product; For example, block 1205 can provide fields for free entry of text strings that enable the merchant to enter audio references (song and artist), video references (film or TV show), text references (books/magazines/periodicals) or other media/culture references for the brand/product.

In block 1207, the merchant executes the Amulet retail application executing on the host computer 53 to interact with the application server 21′ of the cloud service to define (and possibly update) links to other information or sites (brand/product websites, Facebook fan page, Youtube related media, twitter streams, blogs, etc.) related to the goods or services of the merchant as described by the merchant profile information of block 1205.

In block 1209, if not done so already, the merchant connects the Amulet Retail Communication device 51 to the host computer 53 by a data communication interface (i.e., the wired USB link or wireless Bluetooth link) between the host computer 53 and the Amulet Retail Communication device 51. The user executes the Amulet retail application executing on the host computer 53 to transfer (sync) the merchant profile information (pertaining to the respective device 51) to the device 51 for storage in the memory of the microprocessor of the device 51. In one embodiment, the transfer is initiated by the merchant pressing a “Sync” button presented to the user by the Amulet retail application executing on the host computer 53. The merchant profile information is transferred over the data communication interface (i.e., the wired USB link or wireless Bluetooth link) between the host computer 53 and the device 51.

In block 1211, the merchant can decouple the device 51 from the host computer 53, if desired, and locates the device 51 at a desired retail location of the merchant.

In block 1213, the merchant executes the Amulet retail application executing on the host computer 53 to interact with the application server 21′ of the cloud service to define meets/games that are related to the goods and/or services of the merchant. In block 1215, customer users can be invited to the meets/games after forming a connection (or link) to the corresponding goods/services as described below.

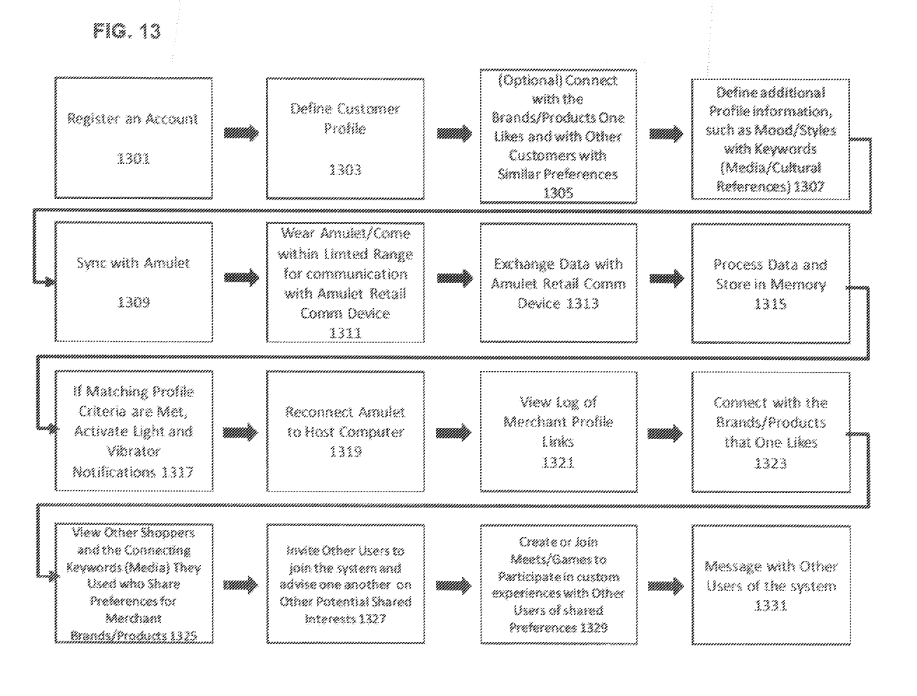

FIG. 13 is a step-by-step description of exemplary operations of Retail Customers using the Amulet fashion piece in the system of FIG. 11.

In block 1301, the user connects the core of the Amulet fashion piece (11A or 11B) to the host computer (12A or 12B) by the data communication interface therebetween (such as a wired USB link or a wireless Bluetooth link). The user executes the Amulet application executing on the host computer to interact with the application server 21′ of the cloud service. In this block, the user registers the hardware (the user's Amulet fashion piece) and sets up a user account. This can involve the following:
user enters the unique serial number on the hardware.
user creates and enters a username for their profile name.
user creates and enters a password to access their online user account.
user enters their real name for identity verification.
user enters their email address.
user enters their phone number.
user installs a software driver on the host computer (where the software driver can correspond to the operating system of the host computer system).

A user interface similar to that of FIG. 6 can be presented to the user of the Amulet application executing on the host processor during block 1301.

In block 1303, the user executes the Amulet application executing on the host computer to interact with the application server 21 of the cloud service to define customer profile information for the user. Alternatively, the Amulet application executing on the host computer alone (without the cooperation of the application server 21) can be used to define customer profile information for the user. Such customer profile information can include the following:
information pertaining to the user—“Who I am”—such as a status message with a maximum of 40 characters, gender of the user (male or female), age of the user, occupation of the user, location information of the user (such as home zip code and or work zip code) and 4 keywords of arbitrary text as specified by the user where each keyword has a maximum of 40 characters; and
information pertaining to the goods or services that the user has an interest in—“What goods/services I am interested in”—such as
   data (such as UPC or other product identifiers) representing goods or services that the user is interest in; such data can be derived from manual selection of the users from a list of goods or services presented to the user as part of block 1303; for example, the user can search through a table of brands/products and select particular entries of interest to the user;
   privacy settings for the customer profile information; the privacy settings are set to control what the other users can view for the brands/products of interest to the particular user;
   other user inputs data from another source (i.e. another website with a user profile feature, such as a social networking site such as Facebook.com); such user input data can be converted or organized into a form data suitable for integration into the user profile information; this could involve algorithms or other functions that translate and convert data into other forms;
   user I/O settings—user can set the vibrate and light functions of the Amulet fashion piece; this allows the hardware to continue to broadcast, receive, and process data from other hardware devices without disturbing the user

In block 1305, the user executes the Amulet application executing on the host computer to interact with the application server 21 of the cloud service to view and possibly connect to (identify as of interest) goods and/or services that are of interest to other users of the service. The other users can be part of a network of users with similar preferences. This network can be derived automatically by processing the profile data of the customers and automatically linking customers that have similar preferences. It can also be derived by personal introductions through meetings and games where a user specifies a link to another user of similar preferences.

In block 1307, the user executes the Amulet application executing on the host computer to interact with the application server 21 of the cloud service to define (and/or update) other profile data of the user. Such other profile data can be media/culture textual references that are indicative of the mood and/or style of the particular user. For example, block 1307 can provide five fields for free entry of text strings that enable the user to enter audio references (song and artist), video references (film or TV show), text references (books/magazines/periodicals) or other media/culture references.

In block 1309, if not done so already, the user connects the Amulet fashion piece to host computer by a data communication interface (i.e., the wired USB link or wireless Bluetooth link) between the host computer and the core of the Amulet fashion piece. The user executes the Amulet application executing on the host computer to transfer (sync) the customer profile information to the core of the Amulet fashion piece for storage in the memory of the microprocessor of the core of the Amulet fashion piece. In one embodiment, the transfer is initiated by the user pressing a “Sync” button presented to the user by the Amulet application executing on the host computer. The user profile information is transferred over the data communication interface (i.e., the wired USB link or wireless Bluetooth link) between the host computer and the core of the Amulet fashion piece.

In block 1311, the user disconnects the Amulet fashion piece from the host computer and wears the Amulet fashion piece and comes within a limited communication range of an Amulet Retail Communication Device 51 as described above. The limited communication range is dictated by the wireless communication range of the wireless transceiver of the Amulet Retail Communication Device 51 and the wireless communication range of the wireless transceiver of the Amulet fashion piece. In one embodiment, such wireless communication ranges are both within 1 to 10 meters (and possibly within 3 to 5 meters).

In block 1313, the Amulet Retail Communication Device 51 exchanges profile information with the Amulet fashion piece. In such data exchange, the merchant profile information stored by the Amulet Retail Communication Device 51 is communicated wirelessly to the Amulet fashion device, and the customer profile information stored by the Amulet fashion device is communicated wirelessly to the Amulet Retail Communication Device 51.

In block 1315, the Amulet fashion piece saves the merchant profile link data received from the Amulet Retail Communication Device 51, and the Amulet Retail Communication Device 51 saves the customer profile link data received from the Amulet fashion piece. The Amulet fashion piece also carries out the profile matching process for the merchant profile link data by matching the merchant profile link data to the stored customer profile information describing the goods or services of interest to the respective Amulet user. As part of the profile matching process of block 1315, the matching may require character-by-character matching between one or more text strings describing mood and/or style of the customer user in relation to corresponding text strings stored as part of the merchant profile information received from the device 51. It is also contemplated that the operation of the device 51 and Amulet fashion piece can be adapted such that if an Amulet user sees a brand or product that they like, they can deliberately go into range of the device 51 to exchange data with the device 51 and thus store the merchant profile information for the product of interest.

In block 1317, the microprocessor of the Amulet fashion piece activates the four light (RGBW) LED assembly as well as the vibrator based on the results of the profile matching process of block 1315 and the user settings. The light(s) and/or vibrator can be activated for a limited duration (such as for a few seconds). In one example, the color of light activated in block 1317 can be determined by the category of matching profile. After data transmission, one of the devices can pause data broadcasting for a brief period to allow other Amulet fashion pieces to connect with the piece that data was just shared with. After two data transmissions without a broadcasting pause, the device can pause its broadcasting to allow other Amulet fashion pieces to transmit data.

In block 1319, the user reconnects the Amulet fashion piece to host computer by the data communication interface (i.e., the wired USB link or wireless Bluetooth link) between the host computer and the core of the Amulet fashion piece. The user executes the Amulet application executing on the host computer to upload the merchant profile link data (whether matched or not) to the host computer via the data communication interface therebetween. The merchant profile link data can be uploaded from the host computer to the cloud service for storage in the database of the cloud service as well as for access and presentation to the user by the application server of the cloud service. Such merchant profile link data can be cleansed of redundancies and filtered according to privacy settings and then viewed by the user through the interaction between the host computer and the application server of the cloud service. For example, the user can access the “My Product Links” section through their account on the user interface presented to the user by the application server similar to that shown in FIG. 8. The Merchant profile links data can be used to track, record, and potentially later analyze information about the retailers and products encountered by the user over time.

The application server 21′ also allows customer users (“shoppers”) to proactively decide which brand/product they would like to connect to within the system. After connecting to a particular brand or product, a respective customer user can be invited to participate in a meeting/game customized for the particular brand or product. The meeting/game can be organized and/or sponsored by the retailer of the particular product.

The application server 21′ also allows customer users to view other users that have connected with that the same or similar brand/product or possibly have similar preferences, and to communicate directly with such other users to form a social network, for example through a meet/message page where the user can send online text messages. Customer users can also choose to remove other users from their social network.

The application server 21′ can also allow the customer users to view brands/products that they are connected to along with mechanisms for establishing additional connections to other brands/products. For example, the user can select from a table of brands/products in order to establish a connection to the selected brands/products. The customer users can also access links to other information sources or online shops related to the brands/products.

The application server 21′ can also allow customer users to access “Meets/Messages” to actively engage in the community fostered by the systems. Meets are messages and events specific to a particular merchant and possibly specific to one or more brands/products of the merchant. Messages allow customer users to communicate amongst each other. Both Meets and Messages allow customer users with similar brand/product preferences to connect to one another as well as to the brands/products that they are likely to be interested in.

Moreover, the service can charge merchants for use of the system. For example, the cloud service can charge merchants per each message invitation with Amulet users. This can be thought as a charge for thoughtful advertising through messaging after permission has already been established through an invitation.

The system of FIG. 11 has many advantages, including:
initiating a new way of engaging and interacting with customers in a real world context, where real people share who they are and what they like with the retailer based on their direct interaction with the product in a retail setting, where retailer shares with real people their brand/product attributes, users are given access to related information and social networks;
forming (and introducing to users) an active community of other users with similar interests and brand/product preferences, which can build and maintain a defined customer community with an atmosphere where brand champions can thrive, increase probability of closing sales, define and drive the community into action (i.e., customers will think of themselves as a real active community of people rather than a hypothetical anonymous demographic, and customers can communicating amongst themselves to provide branding and marketing for the retailer), and can provide communication with the customer community in a way that inspires action (i.e., active and engaged customers will lead to brand recognition, business growth, and sale).
marketers learn who their customers are, who is interested in their products, what other users are connected to, what other brands/products their customers are interested in and have connected to;
allows customer users to self-market and self-promote the brand/products through the network of users simply by sharing with others the things that they like
allows retail customer users to become part of a community of real people communicating with brands/products, which can transform the shopping experience into a social experience where one can meet new acquaintances and become part of a community, can receive better brand/product recommendations, can participate in fun creative activities with other users with similar interests and brand/product preferences, can enliven the shopping experience by serendipitously connecting to the brands/products in the immediate physical surrounding based on the way the user chooses to express himself/herself, can allow the customer user to meet people with similar interests and brand/product preference and connect with other brands/products that the user is likely to be interested in.
applicable to a broad array of retail market segments, including any product class with a strong emotional component to brand: jewelry, fragrances, bags, shoes, apparel, spirits and liquors, household products, books and media, body care products, dining, and entertainment, hospitality; and
applicable to a broad array of retail environments, including shopping malls, boutiques, restaurants, entertainment venues, farmer's markets/permanent or periodic markets with independent producers/retailers, retail chains carrying a variety of products (i.e. Starbucks).

The system of FIG. 11 can also be adapted to connect an Amulet user to groups of people or an affiliation of people. In this example, the Amulet users wears or carries an Amulet fashion piece (11A or 11B) that stores user profile information similar to the user profile information stored by the Amulet fashion piece as described above for person-to-person matching. For example, the user profile information can include a username, gender, age, location, etc. The user profile information can also include information related to interests of the user and possibly common interest categories or themes and/or common interest keywords as described above for person-to-person matching.

A group (or affiliation) of people or an entity employs an Amulet connection device located within a public or private space (such as mall or convention center) in conjunction with an information display related to the group or entity. The amulet connection device includes the basic functionality of the core of the Amulet piece as described above (e.g., a microprocessor with embedded memory for data storage, a wireless transceiver for wireless data broadcast communication to Amulet fashion pieces of retail customers that are located within the limited communication range of the wireless transceiver, and a data communication interface (such as wired USB interface or a wireless Bluetooth interface) for interfacing to a host computer. The Amulet connection device can be powered by mains power via an AC/DC adapter as is well known in the electronic arts. Alternatively, the Amulet connection device can also be powered by a rechargeable battery or other suitable power supply means. The microprocessor memory of the Amulet connection device stores profile information that is related to the group or entity associated with the information display. Such group profile information can characterize the goal(s) or purpose(s) or interests or other useful information of the associated group or entity. The stored group profile information can be specific to the information that is located at or near the Amulet connection device. In this manner, the Amulet connect device can be part of an information space tailored for the specific needs of the group or entity.

The Amulet connection device wirelessly broadcasts the stored group profile information over a limited range (preferably between 1 meter to 10 meters, and more preferably between 3 meters and 5 meters) for wireless communication to one or more Amulet fashion pieces located within such limited range. The Amulet fashion piece of the customer can also wirelessly broadcast its stored user profile information over a limited range for wireless communication to the Amulet connection device. The device receives the user profile information via wireless communication from the Amulet fashion pieces (such profile information is hereinafter referred to as a “user profile link”). The processor of the Amulet fashion piece carries out a profile matching process for the group profile information that it receives via wireless communication from the Amulet connection device (such profile information is hereinafter referred to as a “group profile link”), and controls the indicator device(s) (such as by activating an LED light and/or mechanical vibrator) in accordance with the result of the profile matching process. The profile matching process is configured to automatically determine if the user of the Amulet fashion piece is likely to be interested in the group or entity associated with the Amulet connection device. If interested, the user of the Amulet fashion piece can select or obtain the information related to the group or entity from the public display. These operations can be repeated for profile matching the user of the Amulet fashion piece to other groups or entities. It can also be repeated for profile matching a number of Amulet fashion piece users to a given group or entity. The group profile link information and the user profile link information can be uploaded to a host computer and cloud storage for access and messaging and other social networking tasks similar to the systems of FIGS. 1 and 11.

It is also contemplated that the features of the system of FIG. 11 for connecting retail customers to products or services can be combined with a game or meeting event as described above with respect to FIG. 10. This combination of features can be used to create a social, competitive, and physically specific gaming and shopping experience. i.e. a scavenger hunt involving several brands having profiles with similar interests meet in specific locations, exposing them to specific brands and products, rewarding participants for certain behavior with virtual and/or physical goods and discounts.

In alternate embodiments, the amulet fashion piece as described herein can be substituted by a device that embodies or emulates the basic functionality of the core of the amulet fashion piece (e.g., a microprocessor with embedded memory, a limited range wireless transceiver, input/output devices such as vibrator and visual display, a data communication interface to a host system, and an electrical power supply). For example, such basic functionality of the core of the amulet fashion piece can readily be embodied in a mobile phone device, a smart phone, or other mobile device. In yet another alternate embodiments, the amulet fashion piece and associated host system can be substituted by a device that embodies or emulates the basic functionality of the core of the amulet fashion piece (e.g., a microprocessor with embedded memory, a limited range wireless transceiver, input/output devices such as vibrator and visual display, and an electrical power supply) as well as the functionality of the associated host system as described herein. For example, such device can be a mobile phone device, a smart phone, or other mobile device. It is also contemplated that the electrical power source of the electrical subsystem of the Amulet device can be a passive device, such as a storage capacitor, that is configured to harvest power from environmental sources (such as RF communication, vibration and the like).

There have been described and illustrated herein several embodiments of a small form factor intelligent wireless communication device that is carried or worn by users (and associated methods and systems) that connect people to another or to other entities in a variety of real world scenarios. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. A device that is worn or carried by a user, the device comprising:
an electrical subsystem including a processor, memory, a wireless communication interface for data communication over a maximum range between 1 meters and 10 meters, at least one indicator, and an electrical power source;
wherein the memory is configured to store first profile data and second profile data, the first profile data characterizing at least one trait of the user, and the second profile data characterizing at least one interest of the user;
wherein the processor is configured to transfer the first profile data as stored in the memory to the wireless communication interface for wireless broadcast of the first profile data to at least one other device located within the maximum range of data communication of the wireless communication interface;
wherein the wireless communication interface and processor of the device are configured to receive data communicated by wireless communication from the at least one other device to the wireless communication interface, wherein the received data characterizes a person or group of people or entity or product or service that is associated with the other device;
wherein the processor is configured to process the received data by matching the received data and the second profile data; and
wherein the processor is configured to control the at least one indicator based upon the processing of the received data.

2. A device according to claim 1, wherein:
the processing of the received data is configured to automatically determine if the user is likely to be interested in the person or group of people or entity or product or service that is associated with the other device.

3. A device according to claim 1, wherein:
the other device is similar in form and function to the device.

4. A device according to claim 1, wherein:
the first profile data further characterizes at least one common interest that is shared by the user and possibly other device users;
the second profile data represents at least one specific characteristic of persons that the user is interested in;
the received data represents at least one specific trait or interest of a person that is wearing or carrying the other device as well as at least one common interest that is shared by the person that is wearing or carrying the other device and possibly other device users;
the processing of the received data further includes matching the received data that represents the at least one common interest that is shared by the person that is wearing or carrying the other device to the first profile data that characterizes the at least one common interest that is shared by the user; and
the processing of the received data is configured to automatically determine if the user is likely to be interested in the person that is wearing or carrying the other device.

5. A device according to claim 1, wherein:
the other device is part of a display for the sale or promotion of a particular product or service where the display is located within the limited distance of data communication of the wireless communication interface, and the received data represents at least one specific trait of the particular product or service;
the second profile data represents at least one specific characteristic of products or services that the user is interested in; and
the processing of the received data is configured to automatically determine if the user is likely to be interested in the particular product or service.

6. A device according to claim 1, wherein:
the other device is part of a promotional or information display for a particular group or affiliation of people or entity (such as a sports team or club, social group or club, hobbyist group or club, religious group, political group or company) where the display is located within the limited distance of data communication of the wireless communication interface, and the received data represents at least one specific trait of the particular group or affiliation of people or entity;
the second profile data represents at least one specific characteristic of groups or affiliations of people or entities that that the user is interested in; and
the processing of the received data is configured to automatically determine if the user is likely to be interested in the particular group of affiliation of people or entity.

7. A device according to claim 1, wherein:
the at least one indicator is selected from the group consisting of at least one visual indicator and a vibratory indicator.

8. A device according to claim 7, wherein:
the at least one indicator includes a plurality of visual indicators for emitting different color light; and
the second profile data represents a plurality of different categories or themes that the user is interested in;
wherein the memory of the device stores configuration data that associates a respective category or theme of the second profile data and a corresponding visual indicator, wherein the configuration data is specified by user input and used to control the corresponding visual indicator as a result of the matching of the respective category or theme of the second profile data.

9. A device according to claim 1, wherein:
the first profile data includes profile data of the user selected from the group consisting of gender of the user and age of the user; and
the second profile data includes data selected from the group consisting of gender of people of interest to the user and an age range for people that the user is interested in, and the matching matches the gender and/or age range of the second profile data to corresponding portions of the received data.

10. A device according to claim 1, wherein:
the first profile data includes at least one predefined theme or category that is associated with the user and can be associated with other device users; and
the received data includes at least one predefined theme or category that is associated with the person carrying or wearing the other device, and the matching matches the at least one predefined theme or category of the first profile data to corresponding portions of the received data.

11. A device according to claim 1, wherein:
the first profile data includes at least one keyword that is associated with the user and can be associated with other device users; and
the received data includes at least one keyword that is associated with the person carrying or wearing the other device, and the matching matches the at least one keyword of the first profile data to at least one keyword of corresponding portions of the received data.

12. A device according to claim 11, wherein:
the at least one keyword of the first profile data includes arbitrary text defined by the user or predefined text selected by the user; and
the at least one keyword of the received data includes arbitrary text defined by the person carrying or wearing the other device or predefined text selected by the person carrying or wearing the other device.

13. A device according to claim 11, wherein:
the matching of keywords identifies an exact match between a keyword of the first profile data and a keyword of the corresponding portion of the received data.

14. A device according to claim 11, wherein:
the matching of keywords employs rule based analysis for matching one or more keywords of the first profile data and one or more keywords of the corresponding portion of the received data.

15. A device according to claim 1, wherein:
the processing of the received data employs rule based matching analysis to determine correspondence between the received data and profile data stored in the memory of the electrical subsystem.

16. A device according to claim 1, wherein:
the device includes at least one part that conveys style or fashion.

17. A device according to claim 15, wherein:
the at least one part that conveys style or fashion is a removable cover.

18. A device according to claim 1, further comprising:
at least one clasp for securing the device to a band or necklace worn by the user.

19. A device according to claim 1, further comprising:
a communication interface for interfacing the device to a host computer system.

20. A device according to claim 19, wherein:
the host computer is selected from the group consisting of personal computer (PC), laptop, tablet computer, PDA, MP3 player, e-book reader, and mobile phone.

21. A device according to claim 19, wherein:
the communication interface is selected from the group consisting of USB interface, FireWire interface, serial port interface, IR interface, and Bluetooth wireless interface.

22. A device according to claim 1, further comprising:
at least one user-operated switch for controlling operation of at least one component of the electrical subsystem.

23. A device according to claim 1, wherein:
the electrical power source is selected from the group consisting of a standard battery and a rechargeable battery.

24. A system including:
the device of claim 19; and
a software application executing on the host computer system, wherein the software application is configured to present a user interface that is configured to interact with the user to specify the first user profile data and the second user profile data and to execute a synchronization operation that loads the first user profile data and the second user profile data into the memory of the electrical subsystem of the device via the interface between the host computer system and the device.

25. A system according to claim 24, wherein:
the device stores log data that represents results of the matching as well as the received data that it receives over time; and
the synchronization operation transfers and stores the log data in a user account accessed by operation of the software application executing on the host computer system.

26. A system according to claim 25, wherein:
the software application allows the user to view profile information for other users included in the log data stored in the user account and to communicate to such other users.

27. A system according to claim 25, wherein:
the software application allows the user to view information for groups of people or product or services referenced by the log data stored in the user account.

28. A system according to claim 24, wherein:
the software application allows the user to specify configuration data for configuring the at least one indicator of the device in accordance with results of matching performed by the processor, wherein the synchronization operation further loads the configuration data into the memory of the electrical subsystem of the device via the interface between the networked computer system and the device.

29. A method for facilitating social interaction between people, the method comprising:
providing a plurality of devices that are worn or carried by a plurality of people, each respective device having an electrical subsystem including a processor, memory, a wireless communication interface for data communication over a maximum range between 1 meters and 10 meters, at least one indicator, and an electrical power source, wherein the memory is configured to store first profile data and second profile data, the first profile data representing at least one specific trait or interest of the person wearing or carrying the device as well as at least one common interest that is shared by the person wearing or carrying the device and possibly other device users, and the second profile data representing at least one specific characteristic of persons that the person wearing or carrying the device is interested in;
employing wireless communication between devices to pair devices worn or carried by the plurality of people, wherein a respective device pair is co-located within the maximum range for data communication between the wireless communication interfaces of the respective device pair;
in response to the pairing of a respective device pair, performing a sequence of operations including
configuring the processor for each given device of the respective device pair to transfer the first profile data as stored in the memory of the given device to the wireless communication interface of the given device for wireless communication to the other device of the respective device pair;
configuring the wireless interface of each given device of the respective device pair to receive the first profile data from the other device of the respective device pair, and to transfer the received first profile data to the processor of the given device; and
configuring the processor of each given device to process the received first profile data by matching the received first profile data that represents the at least one specific trait or interest of the person wearing or carrying the other device to the second profile data as stored in the memory of the given device and by matching the received first profile data that represents the at least one common interest that is shared by the person wearing or carrying the other device to the first profile data that represents the at least one common interest that is shared by the person wearing or carrying the given device; and
configuring the processor to control the at least one indicator of the given device based upon the processing of the received data.

30. A method according to claim 29, wherein:
the processing of the received data is configured to automatically determine if the person wearing or carrying the given device of the respective device pair is likely to be interested in the person wearing or carrying the other device of the respective device pair.

31. A method according to claim 29, wherein:
at least one of the devices worn or carried by the plurality of people includes at least one part that conveys style or fashion.

32. A method according to claim 31, wherein:
the at least one part that conveys style or fashion is a removable cover.

33. A method according to claim 29, wherein:
at least one of the devices worn or carried by the plurality of people includes at least one clasp for securing the device to a band or necklace worn by the user.

34. A method for facilitating interaction between a person and a product or a service or a group of people, the method comprising:
providing a user device that is worn or carried by the person, the user device having an electrical subsystem including a processor, memory, a wireless communication interface for data communication over a maximum range between 1 meters and 10 meters, at least one indicator, and an electrical power source, wherein the memory of the user device is configured to store first profile data and second profile data, the first profile data characterizing at least one trait of the user, and the second profile data characterizing at least one interest of the user;
providing a secondary device that is associated with a product or service or group of people or entity, the secondary device having an electrical subsystem including a processor, memory, a wireless communication interface for data communication over a maximum range between 1 meters and 10 meters, at least one indicator, and an electrical power source, wherein the memory of the secondary device is configured to store profile data characterizing the product or service or group of people or entity associated with the secondary device;
employing wireless communication between the user device and the secondary device to pair the user device and the secondary device when the user device and the secondary method are co-located within the maximum range for data communication between the wireless communication interfaces of the user device and the secondary device;
in response to the pairing of the user device and the secondary device, performing a sequence of operations including
configuring the processor for the user device to transfer the first profile data as stored in the memory of the user device to the wireless communication interface of the user device for wireless communication to the secondary device;
configuring the processor for the secondary device to transfer the profile data as stored in the memory of the secondary device to the wireless communication interface of the secondary device for wireless communication to the user device;
configuring the wireless interface of the user device to receive the profile data communicated from the secondary device, and to transfer the received profiled data to the processor of the user device;
configuring the processor of the user device to process the received profile data by matching the second profile data as stored in the memory of the user device and the received profile data; and
configuring the processor to control the at least one indicator of the user device based upon the processing of the received profile data.

35. A method according to claim 34, wherein:
the secondary device is part of a display for the sale or promotion of a particular product or service where the display is located within the limited distance of data communication of the wireless communication interface of the secondary device, and the profile data stored on the memory of the second device represents at least one specific trait of the particular product or service;
the second profile data stored in the memory of the user device represents at least one specific characteristic of products or services that the person wearing or carrying the user device is interested in; and
the processing of the received profile data carried out by the processor of the user device automatically determines if the person wearing or carrying the user device is likely to be interested in the particular product or service.

36. A method according to claim 34, wherein:
the secondary device is part of a promotional or information display for a particular group or affiliation of people or entity (such as a sports team or club, social group or club, hobbyist group or club, religious group, political group or business) where the display is located within the limited distance of data communication of the wireless communication interface of the secondary device, and the profile data stored in the memory of the secondary device represents at least one specific trait of the particular group or affiliation of people;
the second profile data stored in the memory of the user device represents at least one specific characteristic of groups or affiliations of people that the person wearing or carrying the user device is interested in; and
the processing of the received profile data carried out by the processor of the user device automatically determines if the person wearing or carrying the user device is likely to be interested in the particular group of affiliation of people.

37. A method according to claim 34, wherein:
the user device includes at least one part that conveys style or fashion.

38. A method according to claim 37, wherein:
the at least one part that conveys style or fashion is a removable cover.

39. A method according to claim 34, wherein:
the user device includes at least one clasp for securing the user device to a band or necklace worn by the user.

40. A control program that is stored in memory of an electrical subsystem of a device that is worn or carried by a user, wherein the electrical subsystem further includes a processor, a wireless communication interface, at least one indicator, and an electrical power source, the control program executed by the microprocessor to carry out a method comprising:
storing first profile data and second profile data in the memory, the first profile data characterizing at least one trait of the user, and the second profile data characterizing at least one interest of the user;
configuring the wireless communication interface for data communication over a maximum range between 1 meters and 10 meters;
transferring the first profile data as stored in the memory to the wireless communication interface for wireless communication to at least one other device located within the maximum range of data communication of the wireless communication interface;
receiving data supplied by the wireless communication interface, wherein the received data is communicated by wireless communication from one other device located within the maximum range of data communication of the wireless communication interface, wherein the received data characterizes a person or group of people or product or service that is associated with the other device;
processing the received data by matching the received data and the second profile data stored in the memory; and
controlling the at least one indicator based upon the processing of the received data.

41. A control program according to claim 40, wherein:
the processing of the received data is configured to automatically determine if the user is likely to be interested in the person or group of people or product or service that is associated with the other device.
